(19) United States
(12) Patent Application Publication
(10) Pub. No.: US 2002/0184107 A1
(43) Pub. Date: Dec. 5, 2002

(54) Merchandise management method, merchandise recommendation method, and computer program therefor

(75) Inventors: Hiroshi Tsuda, Kawasaki (JP); Kazuo Misue, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 09/960,300

(22) Filed: Sep. 24, 2001

(30) Foreign Application Priority Data
Apr. 18, 2001 (JP) 2001-120093

(51) Int. Cl. G06F 17/60

(52) U.S. Cl. 705/26

(57) ABSTRACT

An online shop is connected to the terminal of a client through a network. The online shop includes a owned merchandise information storage unit (for example, ‘virtual bookshelf’) for storing the information about the merchandise owned by the client, and a merchandise explanation information storage unit. The online shop manages the information about the merchandise owned by the client. The online shop obtains the information from the owned merchandise information storage unit according to an instruction of the client, and provides it for the client.

### BACKGROUND OF THE INVENTION

1. Field of the Invention

The present invention relates to the management, sales, recommendation, etc., of merchandise for which consumers tend to collect a number of similar types of merchandise such as books, CD (compact disks), DVD (digital versatile disk) etc., recording novels, music, pictures, etc., and more specifically to an apparatus and a method for performing relevant processes through a network, and a program, etc. for directing a computer to realizing the method.

2. Disclosure of the Related Art

Recently, various merchandise and services (hereinafter referred to simply as ‘merchandise’) are provided for consumers. For some types of merchandise, consumers tend to collect a number of similar types of merchandise.

On the other hand, there have been an increasing number of transactions through networks. In virtual online shops through networks, merchandise is displayed through the networks, the shops receive orders from clients, and the merchandise is delivered to or provided for the clients as mail-order sales. For example, books are known as merchandise appropriate for mail-order sales, and there have already been some famous companies as online booksellers who sell books through networks. With an increasing number of online shops, it is very significant to successfully discriminate an online shop from a large number of other online shops.

An example of the merchandise for which consumers tend to collect a large number of similar types of merchandise can be CDs, videos, books, goods to be collected, etc. For example, there are big collectors who have collected hundreds of books. When a consumer has a large number of similar types of merchandise, it is desired that the consumer manages the collected merchandise using personal DBs, etc. However, it may be a laborious task for a consumer to manage collected merchandise. Although the collected merchandise have been properly managed, a consumer may mistakenly buy the same merchandise as the already collected merchandise because he or she cannot confirm it away from home.

### SUMMARY OF THE INVENTION

The first object of the present invention is to solve the above mentioned problem. The second object of the present invention is to improve the service provided by online shops for clients by further providing a service to attain the first object.

The present invention is based on the apparatus or the method for communicating information through a network.

The merchandise management apparatus according to an aspect of the present invention includes: a network connection unit for connection to a network; and an owned merchandise management unit for managing the information about the merchandise owned by a consumer based on the designation received from the consumer through the network. Thus, the device having the function of communicating information through the network can manage the information about the merchandise owned by the consumer. The consumer transmits the designated information about his or her owned merchandise to the merchandise management apparatus using a terminal connected to the merchandise management apparatus through the network. According to the transmitted information, the consumer can receive the information about the owned merchandise from the merchandise management apparatus. Therefore, the consumer can obtain at any place the information about his or her own merchandise from the merchandise management apparatus using an arbitrary network terminal, thereby preventing an already owned merchandise from being mistakenly purchased again.

The above mentioned configuration can also be designed such that, when the consumer purchases merchandise through the network, the owned merchandise management unit can automatically designate the purchased merchandise as merchandise already owned by the consumer, thereby effectively managing the information about the purchased merchandise. Additionally, the owned merchandise management unit can also be designed such that the unit can receive the user designation about unnecessary merchandise through the network, and the designation as the consumer owned merchandise can be canceled. Thus, the process performed by the consumer to manage the consumer owned merchandise can be reduced, thereby allowing the consumer to easily manage his or her own merchandise.

Furthermore, when merchandise can be repeatedly used, the owned merchandise management unit can further manage the information about the merchandise ever used by the consumer. Some types of merchandise, for example, most copyrighted articles are not used up. That is, the consumer can use a copyrighted article by borrowing them from his or her friend without buying them. By allowing the owned merchandise management unit to manage the information about the merchandise ever used by the consumer, the consumer can avoid mistakenly buying merchandise not owned but ever used.

With the above mentioned configuration, when the owned merchandise management unit receives an order from a consumer for merchandise, it determines whether or not the consumer has already owned the ordered merchandise according to the information about the merchandise owned by the consumer. If it determines that the consumer has already owned the ordered merchandise, it can transmit the determination result to the consumer. When the consumer places an order for already owned merchandise, the unit notifies the consumer of it, thereby preventing the consumer from mistakenly purchasing the owned merchandise.

According to another aspect of the present invention, a merchandise sales device for selling merchandise to a consumer through a network includes: a sales management unit for managing the sales of merchandise; and an owned merchandise management unit. With the configuration, a service of managing already owned merchandise can be provided for the consumer (client), thereby allowing the manager of the sales device to discriminate the merchandise from the merchandise of other competitors by providing a better service for a client.

Furthermore, according to another aspect of the present invention, a retrieval device for retrieving merchandise includes: the above mentioned owned merchandise management unit; and a retrieval unit for presenting the retrieval result to a consumer based on the information about the merchandise owned by the consumer. To be more practical, when a retrieval result contains the information about the merchandise owned by the consumer, the retrieval unit does not present the information about the merchandise when the retrieval result is presented to the consumer. Otherwise, when the retrieval unit presents a retrieval result to the consumer, it presents the information about the merchandise owned by the consumer and the information about other merchandise not owned by the consumer with each of them discriminated from the other. Thus, the retrieval unit can prevent the unnecessary information in the retrieval results for the consumer about the merchandise from being provided for the consumer.

Furthermore, according to a further aspect of the present invention, a merchandise recommendation device for recommending merchandise to a consumer by transmitting information to the consumer through a network includes: the above mentioned owned merchandise management unit; and a recommendation unit for determining merchandise to be recommended according to the information about the merchandise owned by the consumer, and transmitting the information about the merchandise to be recommended to the consumer through the network. The recommendation unit classifies each piece of merchandise based on an attribute which is the information about the tendency of the taste of the consumer, determines the attribute matching the taste of the consumer based on the information about the merchandise owned by the consumer, and transmits the information about the merchandise classified into the determined attribute to the consumer.

When the merchandise is a copyrighted article such as a book, music, an image, etc., a probable attribute can be an author name, a singer name, a director name, etc. When the merchandise is trading card such as a baseball card, a game card, etc., a probable attribute can be a team name, a category name, etc. A piece of merchandise can be classified based on a plurality of attributes.

Consumers tend to buy merchandise at a number of shops. The purchase history of a client of a shop, that is, the information about the merchandise purchased by a client of a shop, is the information about a part of the merchandise owned by the consumer. Therefore, there is no information enough to correctly obtain the taste of the consumer. As a result, when merchandise to be recommended is determined according to the purchase history, merchandise not matching the taste of a consumer can be recommended to the consumer. According to an aspect of the present invention, merchandise matching the taste of a consumer can be recommended to the consumer by determining the merchandise according to the information about the merchandise owned by the consumer.

The above mentioned merchandise recommendation device can be an online shop which sells a service of recommending merchandise to a consumer. By providing the above mentioned merchandise recommendation device in an online shop selling merchandise, the online shop can sell the merchandise while providing a service of recommending merchandise. In any case, the online shop can improve its own service to be provided for a consumer by more correctly recommending merchandise to the consumer.

With the above mentioned configuration, the recommendation unit can transmit the information about the merchandise input by other consumers when recommendation information about the merchandise is transmitted to a consumer. Thus, the consumer can also obtain the opinions of other consumers about the recommended merchandise.

Furthermore, the recommendation unit can be designed such that the unit extracts a second piece of merchandise which consumers tend to own together with a first piece of merchandise according to the information about the merchandise owned by consumers and transmits the information about the extracted second merchandise to a consumer who owns the first piece of merchandise and does not own the second piece of merchandise. A piece of merchandise which tends to be owned by consumers who own the merchandise as well as another piece of merchandise can be considered to suit the taste of a consumer who owns the other piece of merchandise. Therefore, the recommendation unit can provide a high-quality merchandise recommendation service by extracting the above mentioned merchandise and recommending it to a consumer.

Furthermore, the recommendation unit can be designed such that the unit classifies each piece of merchandise based on an attribute which is the information indicating the tendency of taste, determines the attribute of the taste of a consumer according to the information about the merchandise owned by the consumer, extracts a merchandise classified in another attribute other than the determined attribute, which tends to be owned by consumers who own a piece of merchandise classified in the determined attribute as well according to the information about the merchandise owned by consumers and transmits the information about the other attribute to the consumer. The recommendation unit obtains the attribute of the merchandise which other consumers assumed to have the same taste as the consumer tend to own, and transmits the information about the attribute. As a result, the unit can recommend to the consumer the field (attribute) of new merchandise probably matching the taste of the consumer.

Furthermore, the above mentioned recommendation unit can also be designed to remove the merchandise owned by a consumer from the merchandise to be recommended to the consumer according to the information about the merchandise owned by the consumer. Thus, it can be avoided that the merchandise already owned by the consumer is recommended to the consumer.

Furthermore, according to another aspect of the present invention, a sales agent device for selling unnecessary merchandise for a consumer includes: a network connection unit for connection to a network; and a sales agent unit for receiving the information about unnecessary merchandise from a plurality of consumers through the network, collectively processing the received information about unnecessary merchandise, and presenting the summary result to buyers. Since the sales agent device acts as an agent for selling a plurality of pieces of merchandise in bulk, each consumer is free of sales negotiation, and can sell his or her own merchandise for a higher price than when the consumer negotiates for the sales.

According to a further aspect of the present invention, a merchandise distribution device includes: the sales agent unit; and a sales unit for selling merchandise to a consumer through a network. With the configuration, if the sales agent unit receives the information about unnecessary merchandise from the consumer, and the sales unit has sold other pieces of merchandise to the consumer, then the unit makes arrangements for collecting unnecessary merchandise when another piece of merchandise is delivered to the consumer. Thus, the merchandise distribution device can reduce the delivery fee of the merchandise, thereby successfully improving the service for the consumer who uses the merchandise distribution device.

According to a further aspect of the present invention, the information providing device for providing the information about merchandise for a consumer through a network includes: a collection unit for collecting a document relating to each piece of merchandise based on the reference among the documents in the network; and an information providing unit for transmitting the information about the location of the collected document in the network to the consumer together with the information about the merchandise.

The above mentioned collection unit can be designed to provide a positive sample document group related to a piece of merchandise, and a negative sample document group related to other pieces of merchandise little associated with the merchandise, determines a document to be collected, and collects the document to be determined and collected from the network. For example, there is a strong probability that a document frequently referred to by a document in the positive sample document group, but not referred to by a document in the negative sample document group is a document related to the merchandise. Therefore, the collection unit determines such a document as a document to be collected based on the reference, and collects the determined document. By repeating the collection, a number of pieces of information can be collected about the above mentioned merchandise. The information providing unit provides the collected information for the consumer. Thus, the consumer can easily obtain the information about the above mentioned merchandise.

By appropriately combining the units in the above mentioned aspects of the present invention, one device can be configured.

In a method including the steps of the processes performed with each configuration, substantially the same operation and effect as the device in each of the above mentioned aspects can be obtained. Furthermore, substantially the same operation and effect can also be obtained by reading a program for directing a computer to perform the function of each configuration of the present invention from a computer-readable storage medium, and performing the program. In addition, the program can also be loaded into the computer and executed using a computer data signal embodying the program.

### BRIEF DESCRIPTION OF THE DRAWINGS

The features and advantages of the present invention will be more clearly appreciated from the following description taken in conjunction with the accompanying drawings in which like elements are denoted by like reference numerals and in which:

FIG. 1 shows the configuration of the system including an online shop;

FIG. 2 shows the configuration of an online shop (online bookstore) according to each embodiment of the present invention;

FIG. 3A shows an example of the data structure of a virtual bookshelf by book;

FIG. 3B shows an example of the data structure of a virtual bookshelf by author;

FIG. 3C shows an example of the data structure of a personal comment table;

FIG. 4 shows an example of the data structure of a book master;

FIG. 5 shows an example of the data structure of an popular Web document master;

FIG. 6 is a flowchart of the rough process flow on a list screen;

FIG. 7 shows an example of a new book list screen;

FIG. 8 shows an example of a retrieval list screen;

FIG. 9 is a flowchart of a purchasing screen;

FIG. 10 is a flowchart of the process of setting the information about the books of the same author;

FIG. 11 is a flowchart of the recommending process of an associated author;

FIG. 12 show an example of the author information display screen;

FIG. 13 is a flowchart of the recommending process of an associated book;

FIG. 14 shows an example of a book information display screen (when a book has not been owned);

FIG. 15 shows an example of a book information display screen (when a book has been owned);

FIG. 16 is a flowchart of a sales agent process;

FIG. 17 is a flowchart of a setting process of an owned book list screen;

FIG. 18 is a flowchart of a favorite author book recommending process;

FIG. 19 shows an example of an owned book list screen;

FIG. 20 shows the reference of a book indicated by LT (s), LT (p), LS (d, X), and LS (C, X);

FIG. 21 shows the reference of a document indicated by CC (d, C, X);

FIG. 22 is a flowchart of the document collecting process;

FIG. 23 shows the reference indicated by each set contained in an expression for computing a reference score;

FIG. 24 shows the reference indicated by each set contained in an expression for computing a co-reference score;

FIG. 25 is a flowchart of a variation of the document collecting process;

FIG. 26 is a flowchart of the sales agent process according to the third embodiment of the present invention;

FIG. 27 shows the configuration of the information processing device; and

FIG. 28 shows the loading of data and a program into a computer.

### DESCRIPTION OF THE PREFERRED EMBODIMENTS

An embodiment of the present invention is described below by referring to the attached drawings. In the drawings, the same device is assigned the same reference numeral.

As described above, a method of discriminating a service from services of competitive companies can be, for example, a discount of a sales price, an improved service to a consumer, that is, a client, using an online shop, etc. The method of improving a service to a client can be realized by the following systems.

1. Recommendation Mechanism: The purchase history of a client is managed to recommend merchandise assumed to satisfy the taste, request, etc. of the client. For example, an online bookstore presents a client with the information about the books frequently purchased by other clients who have purchased the book purchased by the client.

2. Improvement of Purchase Interface: The convenience of a client is improved when he or she makes an order for merchandise. For example, the improvement has been suggested by U.S. Pat. No. 5,794,207 which is famous as the ‘One click patent’ of Walker Asset Management Limited Partnership.

3. Sales with other pieces of merchandise: For example, an online bookstore collectively sells books, CDs, videos, etc.

4. Short time from order to delivery to clients

5. Low delivery fee for merchandise to clients

6. Wide selection of merchandise: For example, an online bookstore deals in a wider selection of books.

The main feature of the present invention resides in that the information about the merchandise owned by a consumer is managed by an apparatus capable of communicating information through a network. Thus, a consumer can view the information about the merchandise owned by the consumer at any time.

Another feature of the present invention resides in that an online shop can win a client by managing for the client the information about the merchandise owned by the client. Furthermore, the online shop can improve various services provided for clients such as functions of an interface, a recommendation mechanism, etc. by managing the information about the merchandise owned by the clients.

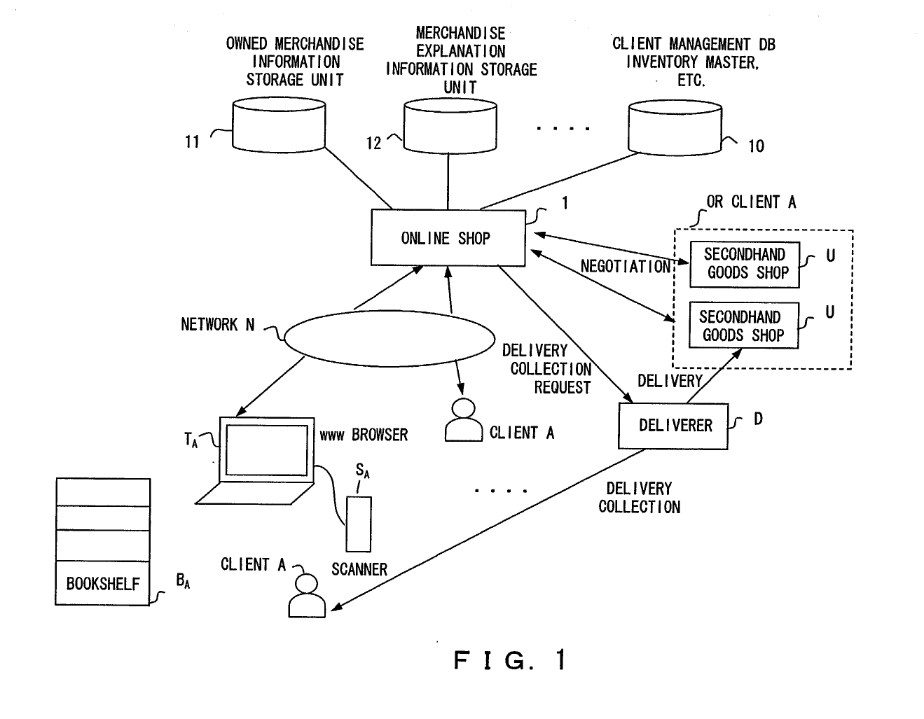

The outline of the system containing an online shop according to the present invention is described below by referring to FIG. 1. As shown in FIG. 1, an online shop 1 is connected to a terminal T_{A} of a client A through a network N. The network N can be a LAN (local area network) such as a dedicated line, etc. and a WAN (wide area network) such as a telephone line, Internet, etc. In FIG. 1, the network N is separately described, but can be included in the same network. The online shop 1 enters a consumer as a client A, and sells merchandise to the client A through the network N. In the following explanation, a consumer is referred to as a client A of the online shop 1.

The online shop 1 deals with a secondhand goods shop U which deal in secondhand goods and a deliverer D. In this system, there are one or more clients A, secondhand goods shops U, and deliverers D.

The client A owns merchandise. The client A is entered as the client A of the online shop 1 by transmitting personal information, etc. to the online shop 1. Furthermore, the client A inputs the information about the merchandise owned by the client A into a terminal T_{A}, and transmits the input information to the online shop 1 through the network N. The client A can input the information about the merchandise owned by the client A using an ISBN (international standard book number), a bar code, etc. When the terminal T_{A} is provided with a scanner S_{A}, the client A reads the bar code applied to the merchandise and inputs the information.

The terminal T_{A} of the client A is an arbitrary device, connected to a communications network, having the function of communicating information. The terminal T_{A} of the client A can be, for example, an installed (desk top type) computer, a telephone set, a facsimile device, and various portable information terminals such as a portable phone, a PHS, an electronic notebook, a palm top computing device, a notebook, etc. Recently, since devices having the function of communicating information with the devices connected to a communications network have remarkably increased in number, information can be obtained through a communications network using a phone, etc.

The online shop 1 comprises a client management database (a database is hereinafter referred to as DB), an inventory master 10, an owned merchandise information storage unit 11, and a merchandise explanation information storage unit 12. The owned merchandise information storage unit 11 stores information about the merchandise owned by the client A. The merchandise explanation information storage unit 12 stores the information identifying merchandise, information defining the information identifying the merchandise and the attribute (author, etc.) of the merchandise, etc., and also stores information about the outline of the merchandise. The client management DB stores personal information, etc. of the client A. The inventory master 10 stores the information about inventory. The client management DB and the inventory master 10 are the same as those in the conventional technology, the detailed explanation is omitted here.

The client A can purchase books at another online shop and an actual store. Therefore, when the online shop 1 manages the merchandise owned by the client A, the information about the merchandise purchased by the client A at other shops than the online shop 1 has also to be stored in the owned merchandise information storage unit 11. In addition to the information about the books purchased by the client A at the online shop 1, the owned merchandise information storage unit 11 also stores the information about the books purchased by the client A at other shops according to the designation of the client A. As a result, the online shop 1 according to the present invention can manage for the client A the merchandise owned by the client A according to the information stored in the merchandise explanation information storage unit 12. The client A can access the online shop 1 at any time through the network using a terminal and obtain the information about the merchandise owned by the client A. Therefore, the client A can avoid mistakenly purchasing the merchandise already owned by him or her. The online shop 1 can thus win the client A by improving the service provided for the client A.

Furthermore, the online shop 1 also has the function of recommending to the client A other pieces of merchandise predicted to satisfy the taste and request of the client A according to the information stored in the owned merchandise information storage unit 11 and the merchandise explanation information storage unit 12. Since the online shop 1 manages the merchandise owned by the client A, it can recommend the merchandise more correctly based on the taste and request of the client A than based on the conventional purchase history.

On the other hand, some types of merchandise can be used up, but others can be repeatedly used without being used up. When the merchandise which is not used up, but can be repeatedly used can be a secondhand article. That is, books, CDs, DVDs, etc. can be secondhand goods. However, it is difficult to personally find a buyer to sell these goods to. The online shop 1 according to the present invention can accept a request to sell unnecessary merchandise from the client A, and sell it as a sales agent for the client A. Upon receipt of the merchandise owned by the client A, that is, the secondhand merchandise from the client A, the online shop 1 negotiates with the secondhand goods shop U dealing in secondhand goods for the client A for the sales of secondhand goods. When secondhand goods are to be sold, the online shop 1 checks the requests to sell secondhand goods from a plurality of clients A so that the clients A can sell their secondhand goods at higher prices than they personally negotiate directly with the secondhand goods shop U, thereby successfully improving the service to the clients A also when unnecessary merchandise is to be sold. A buyer does not have to be a secondhand goods shop U. For example, the online shop 1 can negotiate for the sales of unnecessary merchandise among the clients A.

The online shop 1 can have the deliverer D, who delivers purchased merchandise to the client A, also collect secondhand goods to be sold by the client A and deliver the collected goods to another client A. Thus, when the merchandise purchased by the client A is delivered, unnecessary merchandise can simultaneously be collected. Therefore, the delivery fee can be reduced, thereby improving the service to the client A with respect to the delivery fee of books.

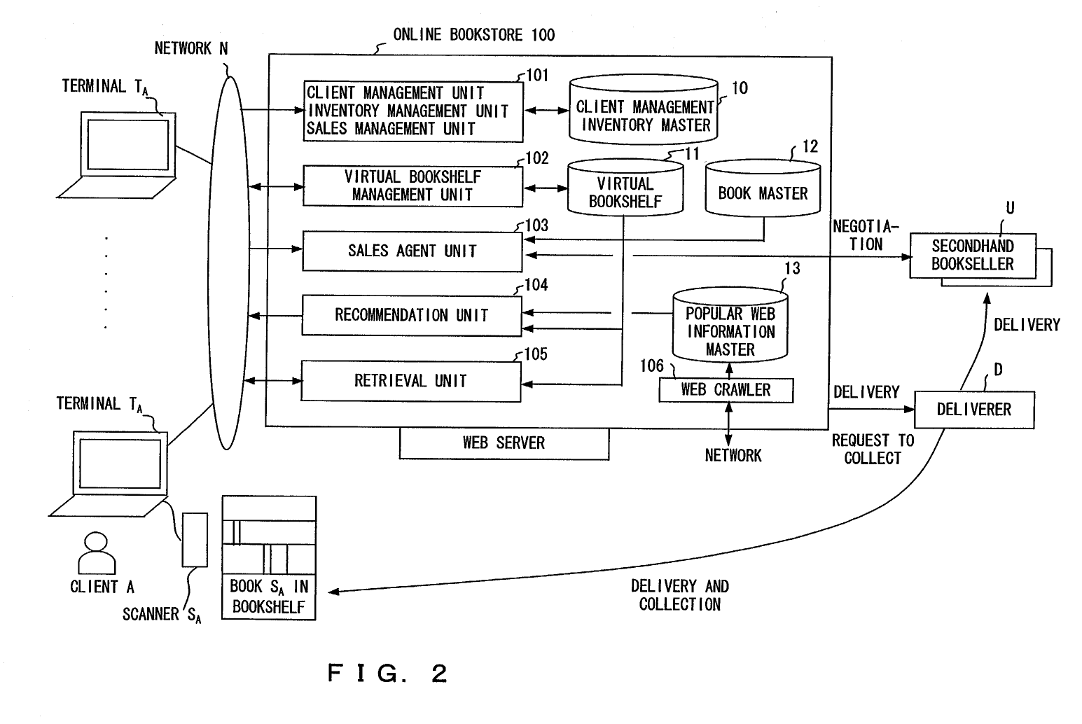

The configuration of an online bookstore according to each embodiment of the present invention is described below by referring to FIG. 2. In the following explanation, it is assumed that the merchandise is a book, but it is not limited to any type of merchandise to be processed by the apparatus, etc. according to the present invention. So far as the sales of the merchandise depends on the taste, request, etc. of the client A for the merchandise, the apparatus, etc. according to the present invention can process the merchandise.

Since the system configuration shown in FIG. 2 is substantially the same as the configuration shown in FIG. 1, the detailed description of the system configuration is omitted here. An online bookstore 100 according to the first embodiment can be realized as, for example, a Web server. As shown in FIG. 2, the online bookstore 100 comprises a client management unit, an inventory management unit, and a sales management unit (hereinafter referred to as a sales management unit) 101, an owned merchandise management unit (virtual bookshelf management unit) 102, a sales agent unit 103, a recommendation unit 104, a retrieval unit 105, a Web crawler (document collection unit) 106, a client management DB and inventory master 10, an owned merchandise information storage unit (virtual bookshelf) 11, a merchandise explanation information storage unit (book master) 12, and an popular Web document master 13.

The sales management unit 101 realizes all functions relating to mail-order sales. To be more practical, the sales management unit 101 presents merchandise to a client A through a network N, manages the inventory of books, accepts an order from the client A, delivers merchandise, etc. Furthermore, the sales management unit 101 manages the information about the clients, the inventory, and the sales of merchandise stored in the client management DB and inventory master 10. Since the sales management unit 101 and the client management DB and inventory management 10 are the same as those in the conventional technology, the detailed explanation is omitted here.

The owned merchandise management unit (virtual bookshelf management unit) 102 manages the information about the merchandise owned by the client A according to the purchase history and the designation of the client A. Furthermore, at an instruction of the client A, the information about the merchandise owned by the client A is presented to the client A through the network N. Since the merchandise described below is assumed to be books, the owned merchandise management unit 102 is referred to as a virtual bookshelf management unit.

The sales agent unit 103 sells for the client A the book owned by the client A to a secondhand goods shop (secondhand bookseller) U at an instruction of the client A. Thus, the client A is free of troublesome negotiations for selling unnecessary merchandise. When merchandise is to be sold, the sales agent unit 103 can collectively process the sales instructions of a plurality of clients A as necessary by referring to the merchandise explanation information storage unit (book master) 12. Furthermore, since the merchandise can be collectively sold, the sales prices of the merchandise can be higher and advantageous to the clients A.

The recommendation unit 104 analyzes the information about the merchandise owned by each client A, and recommends to the client A the merchandise assumed to satisfy the taste and request of each client A based on the analysis result. When the recommendation unit 104 recommends merchandise to the client A, it can be designed to present the information about a Web document relating to the merchandise to be recommended together with the book to be recommended. A Web document refers to a document, an image, etc. published through a network.

The retrieval unit 105 retrieves information about merchandise by referring to the merchandise explanation information storage unit (book master) 12 at an instruction of the client A, and presents a retrieval result to the client A. When the retrieval result is presented, the retrieval unit 105 refers to the owned merchandise information storage unit (virtual bookshelf) 11, and does not present the information about the merchandise owned by the client A. Otherwise, it can be designed to present the merchandise as distinguishable from the merchandise not owned by the client A. When the retrieval result is presented, the retrieval unit 105 can present the information about a Web document relating to the retrieved merchandise together with the retrieval result.

The Web crawler (document collection unit) 106 collects a Web document relating to the information about the merchandise from an arbitrary network. When a Web document is collected, the Web crawler 106 collects the Web document relating to the merchandise based on the reference (link relation) among Web documents without analyzing the contents of the Web document.

The owned merchandise information storage unit (virtual bookshelf) 11 stores the information about the merchandise owned by each of the clients A. The owned merchandise information storage unit 11 comprises an owned merchandise information storage unit by merchandise, an owned merchandise information storage unit by attribute, and a personal merchandise information storage unit. The owned merchandise information storage unit by merchandise stores ownership information about the status of each client A owning each piece of merchandise. The owned merchandise information storage unit by attribute stores the number of pieces of merchandise owned by each client belonging to each attribute, that is, the number of pieces of owned merchandise by attribute. An attribute refers to the information indicating the tendency of the taste, and can be used for classification of merchandise. An attribute can be, for example, an author, a singer, a director, etc. when the merchandise is a book, a music CD, a video DVD, etc.

The personal merchandise information storage unit stores arbitrary information input by each client A about merchandise. Assuming that the merchandise is a book, the owned merchandise information storage unit, the owned merchandise information storage unit by merchandise, the owned merchandise information storage unit by attribute, and the personal merchandise information storage unit are respectively referred to as a virtual bookshelf 11, a virtual bookshelf by book 111, a virtual bookshelf by author 112, and a personal comment table 113 hereinafter.

The merchandise explanation information storage unit (book master) 12 stores the explanatory information about merchandise, that is, each book. For example, the information can be the title of a book, an author name, etc. The merchandise explanation information storage unit (book master) 12 also stores the information defining the merchandise identification information (book identification information) and the attribute identification information (author identification information). Assuming that the merchandise is a book, the merchandise explanation information storage unit 12 is referred to as a book master. The popular Web document master 13 stores the information about a Web document relating to the book collected by the Web crawler 106.

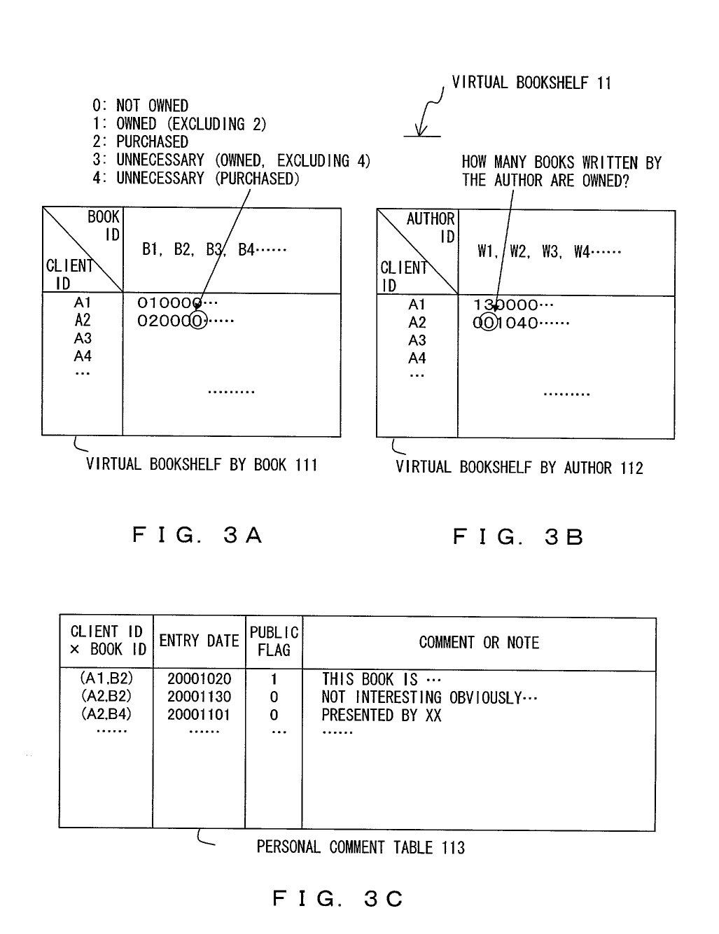

The data structures of the virtual bookshelf 11, the book master 12, and the popular Web document master 13 are described below by referring to FIGS. 3 through 6. First, the data structure of the virtual bookshelf 11 is described by referring to FIG. 3. The virtual bookshelf 11 stores the information about the book owned by the client A. The virtual bookshelf 11 includes a virtual bookshelf by book 111, a virtual bookshelf by author 112, and a personal comment table 113.

The virtual bookshelf by book 111 stores the book ownership information indicating the ownership information about each book for each client A. The book ownership information indicates whether or not the client A owns the book. If the client A owns the book, the information shows whether or not the book has been purchased at the online bookstore 100 and whether or not the book is unnecessary (not required to be owned) because the book has already been read and will not be read again.

For example, in the virtual bookshelf by book 111 shown in FIG. 3A, the ownership information 0, 1, 2, 3, and 4 respectively indicates that ‘the client A does not have the book’, ‘the client A owns the book purchased at a shop other than the online bookstore 100 (hereinafter referred to as ‘the client A purchased the book at another shop’)’, ‘the client A owns the book purchased at the online bookstore 100 (hereinafter referred to as ‘the client A purchased the book at this shop’)’, ‘the client A purchased the book at another shop, but it is now unnecessary’, and ‘the client A purchased the book at this shop, but it is now unnecessary’. In the virtual bookshelf by book 111 shown in FIG. 3A, it proves that the client having the client identification information (hereinafter referred to as a client ID) of A1 for identification of a client A has purchased the book having the book identification information (hereinafter referred to as a book ID) of B2 for identification of a book at another shop. Similarly, it proves that a client having the client ID of A2 purchased a book having the book ID of B2 at this shop, and purchase a book having the book ID of B4 at another shop. The ownership information is stored by the virtual bookshelf management unit 102 based on the input from the client A and the output from the sales management unit 101.

The virtual bookshelf by author 112 stores the number of owned books by author. The number indicates how many books of each author each client owns. For example, in the virtual bookshelf by author 112 shown in FIG. 3B, the client having the client ID of A1 owns one book of the author having the author identification information (hereinafter referred to as an author ID) of W1 for identification of an author, and three books of the author having the author ID of W2. The number of owned books by author is stored and updated by the edition of the virtual bookshelf management unit 102 based on the input of the client A or the sales result from the online bookstore 100.

The personal comment table 113 stores personal book information. The personal book information is the information optionally entered by each client A about a book. The personal book information stores a set of the client A and a client ID, an entry date, a public flag indicating whether or not the information can be public, and the contents of the entered information. The public flag is set ON (1) when the contents of the information can be public. Since the contents of the entered information is optional, various contents, for example, the comment on a book, the name of a person who made the book a present, etc. can be considered. For example, in the personal comment table 113 shown in FIG. 3C, the client having the client ID of A1 has entered the comment on the book B2 ‘This book is . . . ’ on Oct. 20, 2000, and it proves that this comment on the book can be public. The personal book information is stored by the virtual bookshelf management unit 102 based on the input by the client A.

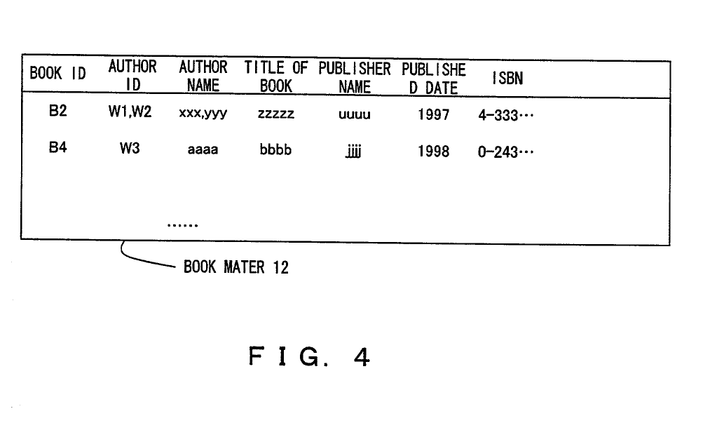

The data structure of the book master 12 is described below by referring to FIG. 4. The book master 12 stores the information defining each piece of identification information about a book, and the explanatory information about the book. To be more practical, the book master 12 stores the book ID (merchandise ID), the author ID (attribute ID), the author name, the title of a book, the publisher name, the publication date, and the ISBN. In the book master 12, the book ID, the author ID, and the ISBN are defined. According to the book master shown in FIG. 4, the author IDs of the book having the book ID of B2 are W1 and W2 (that is, co-authors), the names of the authors are xxx and yyy, and the title of the book is zzzzz. The above mentioned information is stored in the book master 12, and updated as necessary at any time.

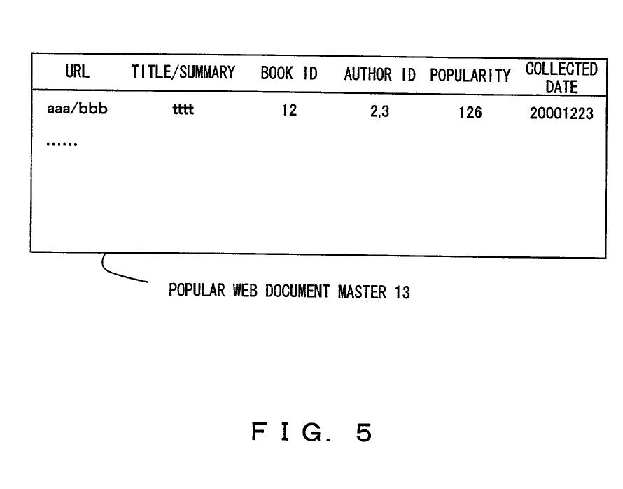

Finally, the data structure of the popular Web document master 13 is described by referring to FIG. 5. The popular Web document master 13 stores the information about the position of the Web document in the network, the title/abstract of the Web document, the book ID and the author ID of the relevant book, the popularity of the Web document, and the collection date on which the Web document has been collected, etc. about each Web document. The information about the position of a Web document in a network can be, for example, URI (uniform resource identifiers). Recently, a URL (uniform resource locator) which is obtained by expressing a part of the functions of the URI is widely used in a network. Described below is a case in which, for example, a URL is used as the information indicating the position of the Web document in the network, but the present invention is not limited to this application. The information is stored in the popular Web document master 13 by the Web crawler (document collection unit) 106 for collecting Web documents.

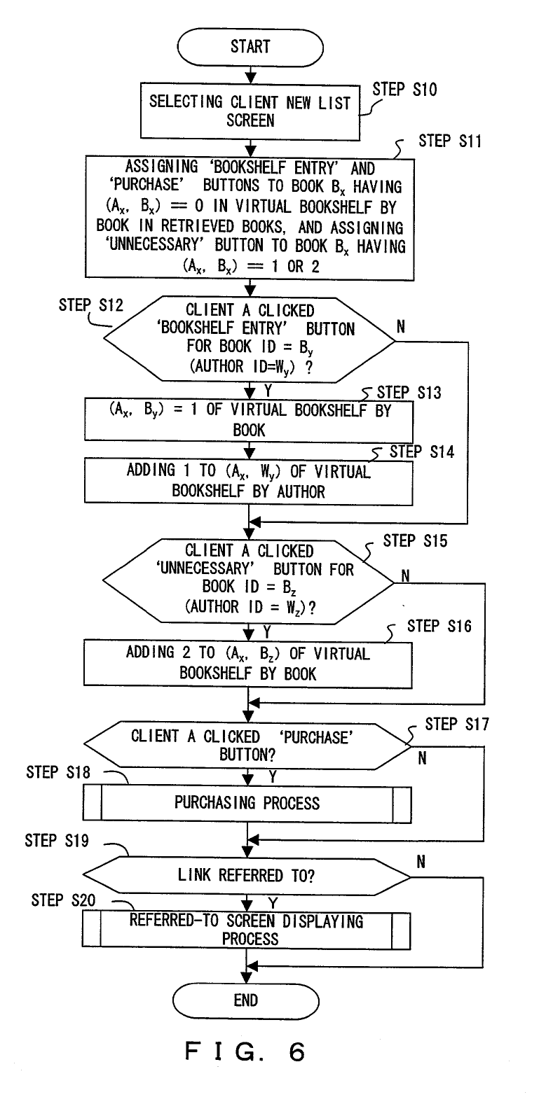

The procedure of the process performed by the online bookstore 100 is described below by referring to FIGS. 6 through 9. It is assumed that the online bookstore 100 according to the present invention adopts a GUI (graphic use interface), but the present invention is not limited to this application.

First, when a book purchased at a shop other than the online bookstore 100 or an unnecessary book is entered in the virtual bookshelf 11, and when an order for a book is issued to the online bookstore 100, the client A performs any of the following processes. According to the information obtained in the processes, the online bookstore 100 can specify the book.

1. The ‘bookshelf entry’, ‘unnecessary’, or ‘purchase’ buttons displayed on the screen are pressed.

2. The ISBN of the book is input.

3. The bar code assigned to the book is read using a scanner S_{A}.

By referring to FIG. 6, the process of the online bookstore 100 setting the book information list screen, and receiving an entry or an order of a book from the client A on the screen. In the description, it is assumed that the book information list screen is a new book list screen, but the substantially the same process is performed in the case of a retrieval result list screen. First, the client A obtains the client ID=Ax of the client A when the client A accesses the online bookstore 100 (not shown in the attached drawings). When the client A designates a list of new books, the retrieval unit 105 determines the book published in a predetermined period from the present point as a new book based on the published date stored in the book master 12. The retrieval unit 105 obtains from the book master 12 the information about the book defined as a new book such as the book ID, the author ID, etc., and sets the author name, the title of a book, and the explanation about the book are set on the screen (step S10). Furthermore, the retrieval unit 105 embeds the links to the author information display screen and the book information display screen respectively into the portions displaying the author name and the title of the book on the screen.

Then, the retrieval unit 105 refers to the virtual bookshelf by book 111 using the book ID of each book of the client ID=Ax, and obtains the ownership information of each book for the client A. The retrieval unit 105 sets the ‘bookshelf entry’ and ‘purchase’ buttons at a predetermined position on the screen corresponding to the book not owned by the client A. Similarly, the retrieval unit 105 changes the display format of the information about the book owned by the client A so that the book can be distinguished from a book not owned by the client A, and sets an ‘unnecessary’ button at a predetermined position corresponding to the book on the screen (step S11). To be more practical, assuming that the book ID of a book is Bx, the retrieval unit 105 sets the ‘bookshelf entry’ and ‘purchase’ buttons on the screen when the ownership information corresponding to the client ID=Ax and the book ID=Bx (hereinafter referred to as corresponding to (Ax, Bx)) is 0 in the virtual bookshelf by book 111. Furthermore, when the ownership information corresponding to (Ax, Bx) is 1 or 2, the retrieval unit 105 changes the display format of the information about the book, and sets the ‘unnecessary’ button on the screen. As an example of changing the display format, the display color of the title of a book is changed, the display of the explanation about the book is suppressed, etc.

The retrieval unit 105 outputs the set screen to the terminal T_{A} of the client A, and waits for the input of the client A. When the client A presses the ‘bookshelf entry’ button (Yes in step S12), the virtual bookshelf management unit 102 enters the book corresponding to the pressed button in the virtual bookshelf 11 as a book ‘purchased at another shop’. To be more practical, the virtual bookshelf management unit 102 obtains the book ID, for example, By, of a book corresponding to the pressed button. The virtual bookshelf management unit 102 refers to the virtual bookshelf by book 111 using the client ID=Ax and the book ID=By, and updates the ownership information corresponding to (Ax, By) into 1.

Then, the virtual bookshelf management unit 102 increments by 1 the number of books written by the author and owned by the client A (step S14). To be more practical, the virtual bookshelf management unit 102 obtains the author ID, for example, Wy, of the author of the book for which the ‘bookshelf entry’ button has been pressed. Then, the virtual bookshelf management unit 102 refers to the virtual bookshelf by author 112 using the client ID=Ax and the author ID=Wy, and increments by 1 the number of owned books by author corresponding to (Ax, Wy).

When the client A presses the ‘unnecessary’ button (Yes in step S15), the virtual bookshelf management unit 102 enters the book corresponding to the pressed button as an unnecessary book in the virtual bookshelf 11. To be more practical, the virtual bookshelf management unit 102 obtains the book ID, for example, Bz, of the book corresponding the pressed button. Then, the virtual bookshelf management unit 102 refers to the virtual bookshelf by book 111 using the client ID=Ax and the book ID=Bz, and increments by 2 the ownership information corresponding to (Ax, Bz) (step S16). At a predetermined timing, the sales agent unit 103 performs a selling process (described later) on a book entered as an unnecessary book.

When the client A presses the ‘purchase’ button (Yes in step S17), the sales management unit 101 performs the purchasing process (described later) on the ordered book (step S18). When the client A refers to the link (Yes in step S19), the retrieval units 105 and the recommendation unit 104 perform the displaying process on the referenced screen (step S20), thereby terminating the process.

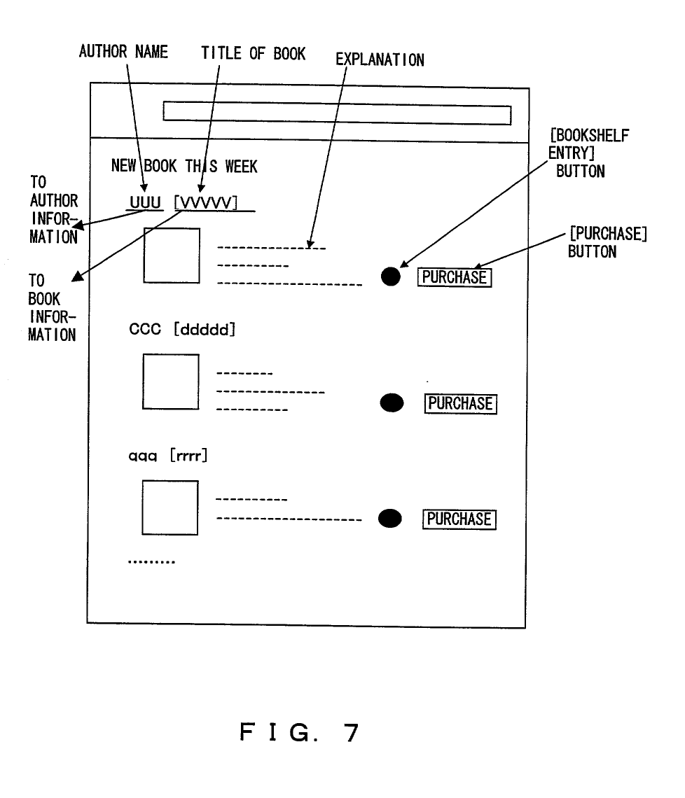

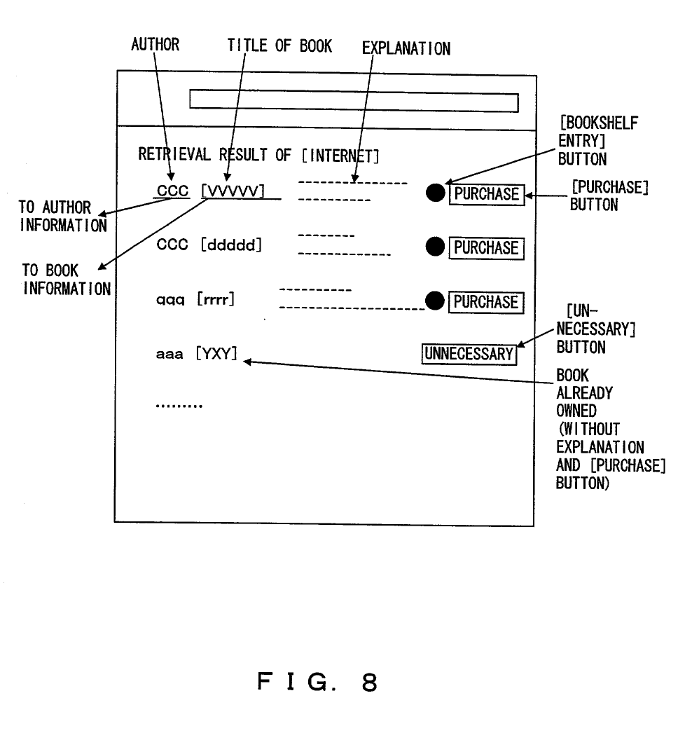

FIG. 7 shows an example of the new book list screen. FIG. 8 shows an example of a list screen of the result of retrieving a book using ‘Internet’ as a key. As shown in FIGS. 7 an 8, the author name of a book not owned by the client A, the title of the book, and the explanation about the book are displayed on the screen. In the position corresponding to each book, the ‘bookshelf entry’ button and ‘purchase’ are indicated. The display of the explanation about the book owned by the client A is suppressed, and the ‘unnecessary’ button is provided in the position on the screen corresponding to the book. In FIGS. 7 and 8, when the client A selects (clicks) the author name or the title of a book, the link respectively to the author information display screen (described later) or the book information display screen (described later) is referred to.

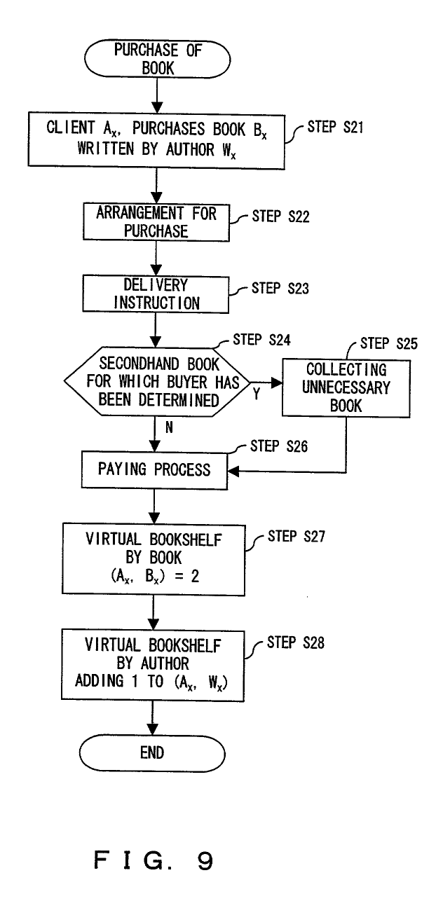

FIG. 9 shows the purchasing process on a book. This process corresponds to step S18 shown in FIG. 6. The purchasing process is also performed by the client A inputting the ISBN or the bar code of a desired book other than by the client A pressing the ‘purchase’ button on the list screen.

For example, if the client A having the client ID=Ax designates the purchase of a book having the book ID=Bx and the author ID=Wx (step S21). The sales management unit 101 obtains the corresponding ownership information by searching the virtual bookshelf by book 111 using the book ID and the client ID. The sales management unit 101 determines whether or not the client A owns the book according to the obtained ownership information, and sells the book if the client A has not owned the book. If the client A has owned the book, the unit notifies the client A that he or she has already owned the book (not shown in the attached drawings).

According to the present embodiment, since the ‘purchase’ button is not set on the screen for an owned book as described above by referring to FIG. 6, the determination is unnecessary when the ‘purchase’ button is pressed. When the client A does not obtain the book, or when the client A still requests to purchase the book although the client A receives a notification that he or she has already owned the book, the sales management unit 101 sells the book (step S22). Since the process is the same as the conventional process, the explanation is omitted here. Then, the deliverer D is instructed to deliver the ordered book to the client A (step S23). Since the process is also the same as the conventional process, the explanation is omitted here. Furthermore, the sales management unit 101 refers to a buyer list not shown in the attached drawings using the client ID of the client A requesting to purchase the book, and determines whether or not there is a book owned by the client A and is to be sold to a specified buyer (step S24). The buyer list stores at least the book ID of the book to be sold to a specified buyer, the image data of the client A requesting to sell the book, and the information identifying the buyer.

When there is a book owned by the client A and is to be sold to a specified buyer (Yes in step S24), the sales management unit 101 instructs the deliverer D to collect the book to be sold to a specified buyer when the purchased book is delivered to the client A (step S25). The sales management unit 101 deletes the collected book from the buyer list. Thus, when a purchased book is delivered, an unnecessary book can also be collected, thereby reducing the delivery fee as compared with the conventional process. If there is no book to be sold to a specified buyer (No in step S24), the sales management unit 101 does not perform the process in step S25.

Then, the sales management unit 101 performs the process on the payment of the purchase price (step S26). Since the process is the same as the conventional process, the explanation is omitted here. If the virtual bookshelf management unit 102 confirms that the client A has paid the purchase price, it refers to the virtual bookshelf by book 111 using the client ID=Ax of the client A, and the book ID=Bx of the purchased book, and the ownership information corresponding to (Ax, Bx) is updated into 2 (step S27). Thus, the purchase of the book having the book ID=Bx by the client A at the online bookstore 100 is entered in the virtual bookshelf 11.

Next, the virtual bookshelf management unit 102 refers to the virtual bookshelf by author 112 using the client ID=Ax of the client A and the author ID=Wx of the purchased book, and increments the number of owned books by author corresponding to (Ax, Wx) by 1 (step S28), thereby terminating the process. As shown in steps S27 and S28, a purchased book is automatically entered in the virtual bookshelf 11 when it is purchased at the online bookstore 100. Therefore, the client A can easily use the virtual bookshelf 11.

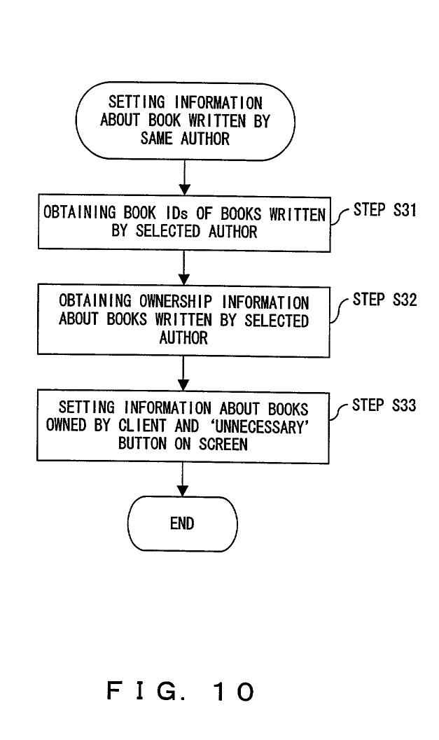

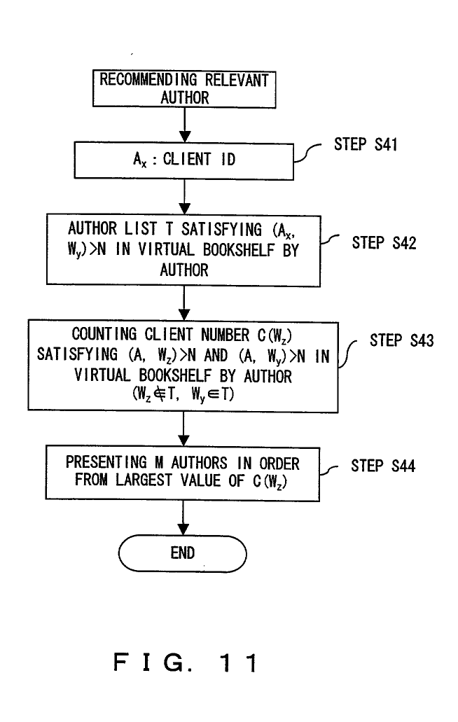

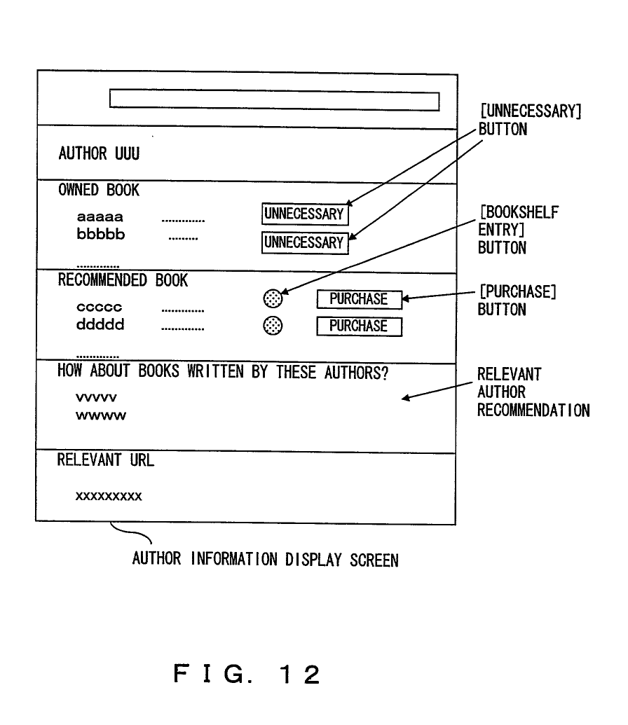

The process of setting the author information display screen is described below by referring to FIGS. 10 and 11. This process corresponds to step S20 shown in FIG. 6 when the client A refers to the link to the author information. FIG. 12 shows an example of the author information display screen. As shown in FIG. 12, the author name of the selected author, the information about the books written by the author and owned by the client A, the information about the books written by the author but not owned by the client A, the information recommending an author (hereinafter referred to as a relevant author) assumed to interest the client A, and a Web document about the author are displayed on the author information display screen. Described below is the procedure of setting each piece of the above mentioned information on the screen. In the explanation below, it is assumed that the client A having the client ID=Ax has referred to the link to the author information about the author by selecting (clicking) the author name of the author having the author ID=Wx.

1. Information About the Books Written by the Author and Owned by the Client A

As shown in FIG. 10, the retrieval unit 105 obtains the book IDs of the books having the author ID=Wx by searching the book master 12 using the author ID=Wx (step S31). The retrieval unit 105 obtains the ownership information about each book for the client A using the client ID=Ax and each book ID (step S32). The retrieval unit 105 sets the information (stored in the book master 12) about the books whose ownership information is 1 or 2 on the screen, and sets the ‘unnecessary’ buttons in positions corresponding to the books (step S33). Like the list screen, a link to the book information display screen is embedded for each book in the title of each book.

2. Information About the Books Written by the Author and not Owned by the Client A

Substantially the same process is performed as in the case of the books owned by the client A. The difference is that, in step S33 shown in FIG. 10, the retrieval unit 105 sets the information about the book whose ownership information is 0 on the screen, and sets the ‘bookshelf entry’ and ‘purchase’ buttons in the position corresponding to the books.

3. Information Recommending Relevant Authors

As shown in FIG. 11, the recommendation unit 104 first searches the virtual bookshelf by author 112 using the client ID=Ax of the client A, thereby obtaining the number of owned books by author of books owned by the client A (step S41). The recommendation unit 104 extracts the author ID of the author whose number of owned books by author is larger than a predetermined number N, and generates a list T of extracted author IDs (step S42). That is, a list of the author IDs=Wx satisfying (Ax, Wx) >N is generated. Thus, a list of the authors of whose books are often read by the client A having client ID=Ax (hereinafter referred to as favorite authors) can be obtained.

Then, the recommendation unit 104 refers to the virtual bookshelf by author 112, and counts the number of clients A having the numbers of owned books by author of the author on the list T larger than a predetermined value and having the numbers of owned books by author of the author not on the list T larger than a predetermined value for all clients A and for all authors not on the list T. That is, assuming that the authors Wz and Wy respectively indicate (Wz not in T, Wz∉T) and (Wy in T, Wy∈T), the number C (Wz) of the clients A satisfying (A, Wz)>N, and (A, Wy)>N is counted (step S43).

Then, the recommendation unit 104 sequentially extracts the number m of the authors not in the list T having larger counted number C (Wz) of clients, and the information about the extracted authors, for example, the names of the authors, etc. is set on the screen (step S44). Thus, the author whose book the client A has not read yet and whose book is assumed to interest the client A can be recommended to the client A. Like the list screen, a link to the author information display screen for each author is embedded for each author name.

4. Web Document About an Author

The retrieval unit 105 searches the popular Web document master 13 using the author ID of a selected author, and obtains the URL or the title of the Web document relating to the selected author. The retrieval unit 105 sets the obtained URL or title on the screen, and embeds the link to the Web document. The Web documents can be displayed in order from the highest popularity, that is, from the most popular document in the network. They can also be displayed in order from the latest collection date, that is, from the newest document. The collection of popular Web documents is described later.

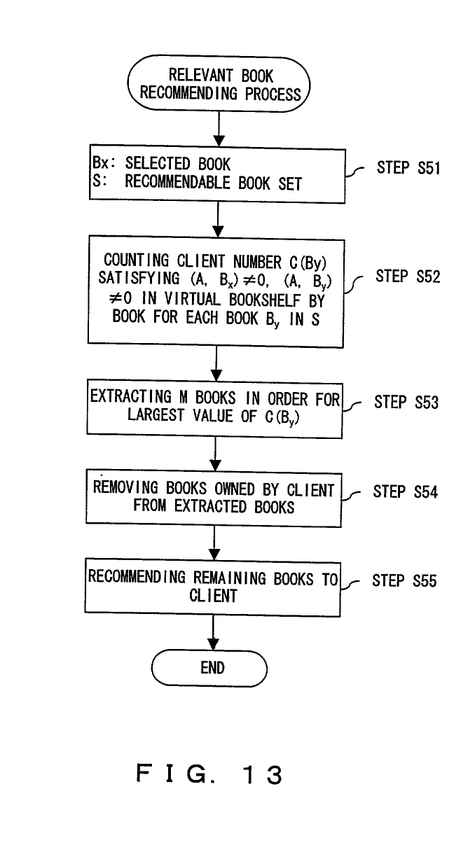

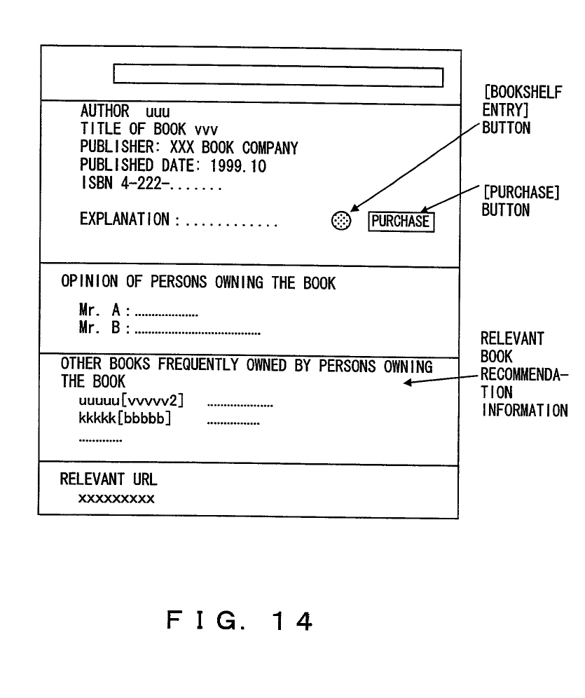

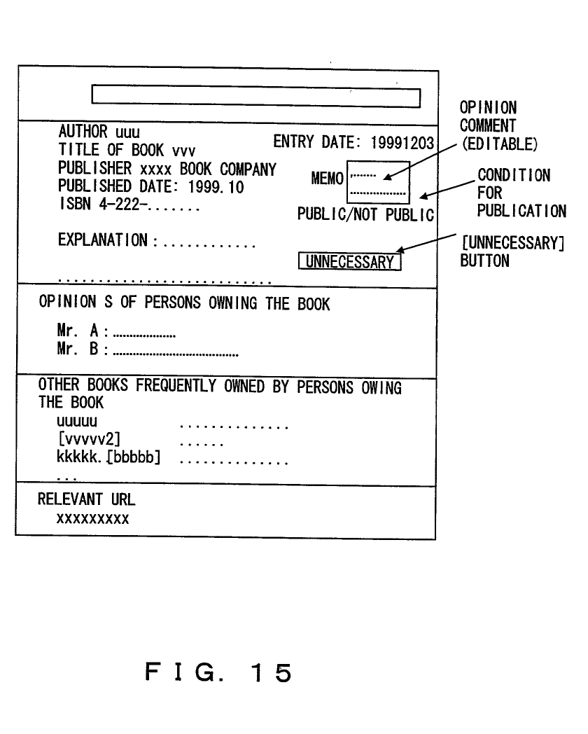

The process of setting the book information display screen is described below by referring to FIG. 13. This process also corresponds the process in step S20 shown in FIG. 6 performed when the client A refers to the link to the book information. FIGS. 14 and 15 show examples of book information display screens. FIG. 14 shows a book information display screen about the books not owned by the client A. FIG. 15 shows a book information display screen about the books owned by the client A. As shown in FIGS. 14 and 15, the information about the selected books, the opinions on the book, etc., and the Web documents relating to the book and the information recommending other books (hereinafter referred to as relevant books), which the other clients A owning the selected book also tends to own, are displayed on the book information display screen. The difference between the FIGS. 14 and 15 is that the ‘bookshelf entry’ button and the ‘purchase’ button are displayed in the case shown in FIG. 14, and the personal book information and the ‘unnecessary’ button are displayed in the case shown in FIG. 15. The procedure of setting each piece of information on the screen is explained in order. In the explanation below, it is assumed that the client A having the client ID=Ax has referred to the link to the book information about the book by selecting a title of the book having the book ID=Bx.

1. Information Explaining Books

The retrieval unit 105 searches the book master 12 using the book ID of a selected book, and obtains the information explaining the book. The retrieval unit 105 sets the obtained information on the screen.

2. Opinions, etc. on the Book

The retrieval unit 105 extracts the information about the selected book by searching the personal comment table 113 using the book ID of the selected book, and sets on the screen the information whose public flag is ON (1) in the extracted information.

3. Information Recommending Relevant Books

As shown in FIG. 13, the online bookstore 100 first sets a set S of recommendable books (hereinafter referred to as a recommendable book set) such as new books, books in the inventory, etc. (step S51). All books transacted at the online bookstore 100 can be set as the recommendable book set S.

Then, the recommendation unit 104 obtains the ownership information about the selected book and each book By contained in the recommendable book set S (the selected book is excluded from the S) from the virtual bookshelf by book 111. Then, the recommendation unit 104 counts the number of the clients A owning both selected books and books contained in the recommendable book set S for each book in the recommendable book sets S (step S52). That is, assuming that the selected book has the book ID=Bx, and the book contained in the recommendable book set S has the book ID=By, the recommendation unit 104 counts the number C (By) of the clients A indicating (A, Bx)≠0 and (A, By)≠0.

The recommendation unit 104 extracts m books from the recommendable book set S in a descending order of the number of counted clients A each of which own the selected bool. Other books owned together with the selected book owned by a number of clients A are expected to interest the client A owning the selected book as a favorite book. Then, the recommendation unit 104 searches the virtual bookshelf by book 111 using the book IDs of the extracted books and the client ID=Ax of the client A, and obtains the ownership information about the extracted books. The recommendation unit 104 removes the book IDs of the books whose ownership information is 1 or 2, that is, the books owned by the client A, from the extracted book IDs (step S54), sets the information explaining each book obtained from the book master 12 using the remaining book IDs on the screen, and recommends the books (step S55). Thus, books not yet read by the client A having the client ID=Ax, and expected to interest the client A can be recommended to the client A.

4. Web Document Relating to the Book

The retrieval unit 105 searches the popular Web document master 13 using the book ID of the selected book, and obtains the URL or title of the Web document relating to the selected book. The retrieval unit 105 sets the obtained URL or title on the screen, and embeds the link to the Web document. The collection of the popular Web document is described later.

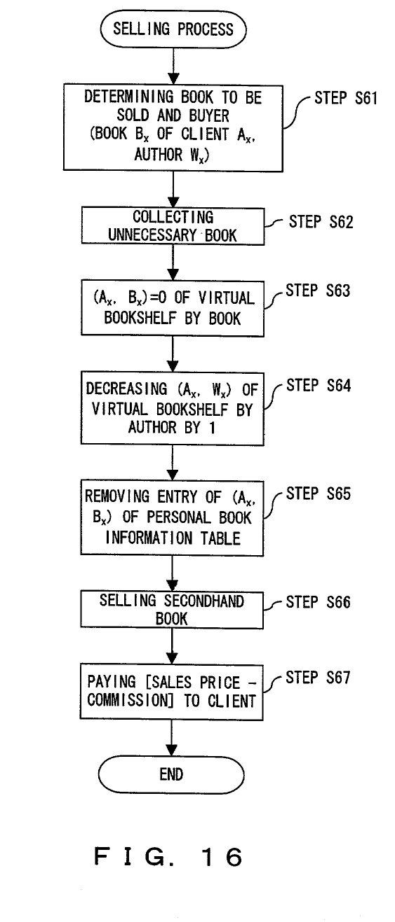

The sales agent process for books is described below by referring to FIG. 16. The sales agent process is performed at a predetermined timing, for example, at a predetermined time every day.

First, the sales agent unit 103 refers to the virtual bookshelf by book 111 at a predetermined timing, retrieves a book set as ‘unnecessary’, and obtains the client ID=Ax of the client A owning the book, and the book ID=Bx of the book. That is, the sales agent unit 103 obtains the ownership information (Ax, Bx) indicating 3 or 4. Then, the sales agent unit 103 collectively processes the sales requests of the books received from the clients A. For example, the sales agent unit 103 refers to the book master 12, and collects the books separately owned by a number of clients A into a set of books. To be more practical, for example, when a set of books 1 and 2 are separately owned by two clients A, the sales agent unit 103 collects the two books into a set of books. Thus, the clients A can sell the books at a higher price than in the case in which the books are separately sold to a secondhand bookseller U. The sales agent unit 103 determines the buyer of each book by negotiating with the secondhand bookseller for the sales of books at the collectively processed sales requests of the clients A (step S61).

The process is described below on the assumption that the buyer of the book having the book ID=Bx, the author ID=Wx, the client ID=Ax of the client owning the book has been determined.

First, the sales agent unit 103 stores in the buyer list not shown in the attached drawings the information about the book for which a buyer has been determined. Then, it is confirmed that the book for which a buyer has been determined has been collected (step S62). The collection can be confirmed based on the input from the manager of the online bookstore 100.

When the collection of a book is confirmed, the sales agent unit 103 searches the virtual bookshelf by book 111 using the client ID=Ax and the book ID=Bx of the book. As a result of the search, the obtained ownership information is updated into 0 (step S63). Then, the sales agent unit 103 searches the virtual bookshelf by author 112 using the client ID=Ax and the author ID=Wx. As a result of the search, the obtained number of owned books by author is decremented by 1 (step S64). Furthermore, the sales agent unit 103 searches the personal comment table using the client ID=Ax, and the book ID=Bx. If the client A has entered the personal book information about the book as a result of the search, the personal book information is deleted (step S65). Thus, the sales agent unit 103 automatically updates the information stored in the virtual bookshelf 11 such that the collected book can be designated as a book not owned.

When the book is collected, the sales agent unit 103 can update the ownership information such that indicates a collected book instead of performing the processes in steps S63 through S65. However, in this case, it is necessary to define in advance the value indicating ‘sold’ as ownership information. Thus, collected books can be discriminated from the books not owned, thereby preventing the books which are unnecessary and sold from being purchased again.

The sales agent unit 103 sells the books to the secondhand bookseller U selected as a buyer (step S66), and pays the amount obtained by subtracting the commission, etc. from the sales price to the client A (step S67), thereby terminating the process.

According to the present invention, the client A can view the information stored in the virtual bookshelf 11, that is, the information about the owned books through the network N. The procedure of setting the screen displaying a list of owned books (hereinafter referred to as an owned book list screen).

When the client A instructs the online bookstore 100 to display the owned book list screen (step S71), the virtual bookshelf management unit 102 searches the virtual bookshelf by book 111 using the client ID of the client A, and obtains the book ID of each book owned by the client A, that is, each book for which the ownership information indicates 1 or 2 (step S72). Then, the virtual bookshelf management unit 102 obtains the information about each book by searching the book master 12 using the book ID of each of the obtained books (step S73). Furthermore, the virtual bookshelf management unit 102 searches the personal comment table 113 using the book ID of each of the obtained books and the client ID of the client A. When personal book information is entered, the virtual bookshelf management unit 102 obtains the personal book information (step S74). Then, the virtual bookshelf management unit 102 sets the information about books on the screen, and sets a ‘unnecessary’ button, a personal book information input column, and a column for designation as to whether or not the information can be made public at predetermined positions corresponding to each book on the screen (step S75). If the personal book information has been obtained in step S74, the contents are displayed in the personal book information input column. The recommendation unit 104 sets the information recommending a book of a favorite author of the client A. The process of recommending a book of a favorite author is described later.

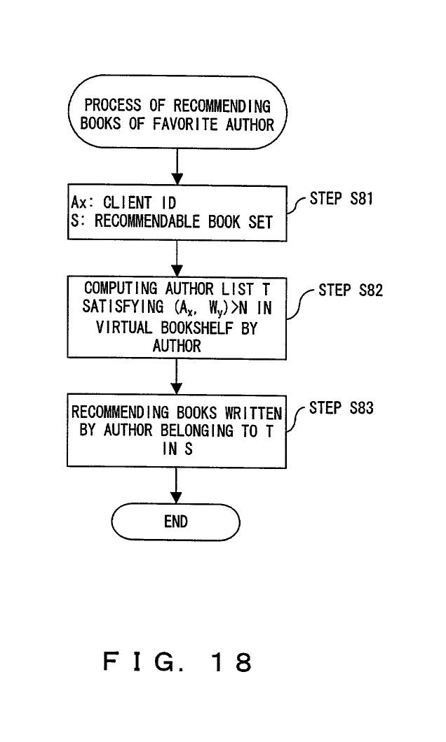

The process of recommending a book of a favorite author is described below by referring to FIG. 18. The online bookstore 100 sets the above mentioned recommendable book set S (step S81). Then, the recommendation unit 104 extracts the author ID of an author whose number of owned books by author is larger than N by searching the virtual bookshelf by author 112 using the client ID=Ax of the client A, and generates a list T of the extracted author ID (step S82). The process in step S82 is the same as the process in step S42.

The recommendation unit 104 extracts a book contained in the recommendable book set S, and whose author ID of the author of the book is contained in the list T (step S83). Then, the recommendation unit 104 removes the book IDs of the books owned by the client A from the book IDs of the extracted books (step S84), sets the information about each book obtained from the book master 12 on the screen based on the remaining book IDs, and recommends the books (step S85). Since steps S84 and S85 are the same as steps S54 and S55 shown in FIG. 13, the detailed explanation is omitted here. Thus, a book which has not been read by the client A having the client ID=Ax, and is written by an author expected to interest the client A can be recommended to the client A.

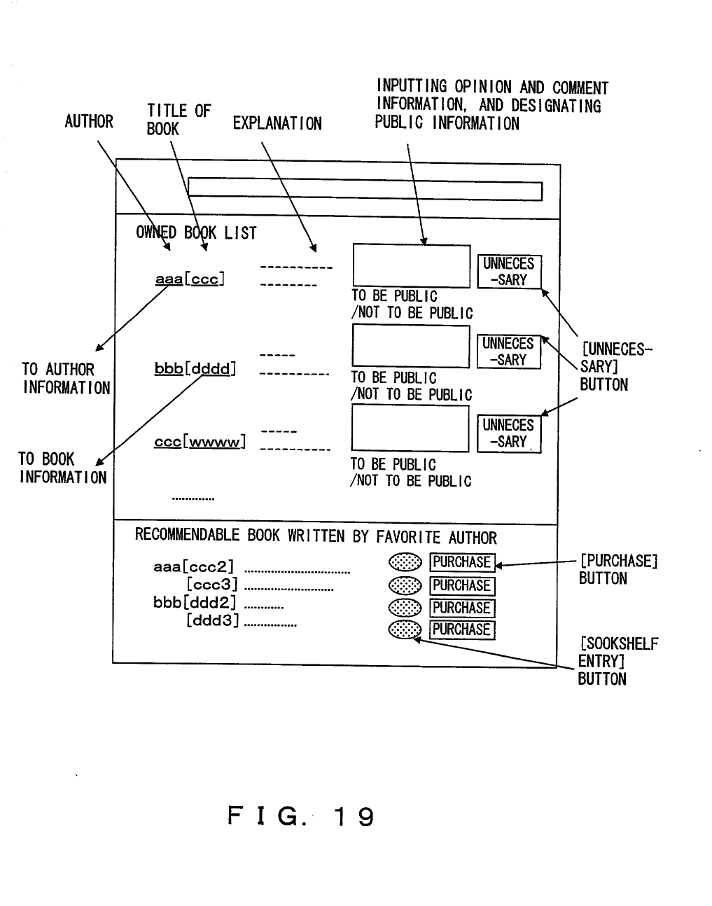

FIG. 19 shows an example of the owned book list screen. The owned book list screen displays a list of books owned by the client A. As shown in FIG. 19, the information about the title of a book, the author name, etc. of the book owned by the client A, the column for entry and display of the personal book information about each book, and the information recommending a book of a favorite author are displayed on the owned book list screen. When the personal book information is entered, the client A inputs the contents of the information into the column corresponding to the book into which information is to be input, and designates whether or not the information can be public. If the client A designates the entry of the personal book information, the virtual bookshelf management unit 102 stores the input information and the input date in the personal comment table 113. The ‘unnecessary’, ‘purchase’, and ‘bookshelf entry’ buttons and the links to the author information and the book information are the same as those on the above mentioned list screen, etc.

The client A can view the information about the book actually accommodated in the bookshelf through the network N on the owned book list screen. By performing the entering process, etc. on the owned books in the virtual bookshelf 11, the client A can easily manage the owned books. Furthermore, when the client A buys a book at the online bookstore 100 and other bookstores, the client A can confirm the information about the owned books anywhere.

Described below is the process of collecting Web documents. When the document collection unit 106 collects Web documents about a book, it collects the Web documents containing the title of a book or/and the author name of the book in the text, etc., and stores the book ID of the book or/and the author ID of the author contained in the text, etc. of the Web documents in the popular Web document table. An appropriate Web document can be collected in a method other than the above mentioned method. Described below is another collecting method. First, the available notation is described. Hereinafter, a Web document can be referred to simply as a document.

LT(B) indicates a referred document (link-target document) set of a document group B.

LT(p) indicates a referred document set of a document p.

LS(d, X)={c∈|c refers d} indicates a set of documents referring to the document d in the document set X.

LS(C, X)={c∈X|∃d∈C, c refers d} indicates a set of documents in the document set X referring to a document in the document set C.

CC(d, A, X)=LS(d, X) ∩LS (C, X) indicates a set of documents in the document set X referring to both a document d and at least one document in the document set C.

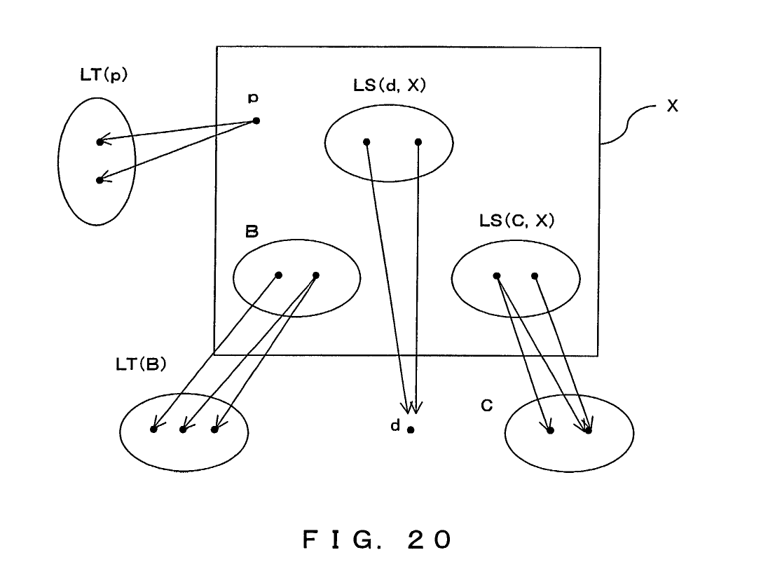

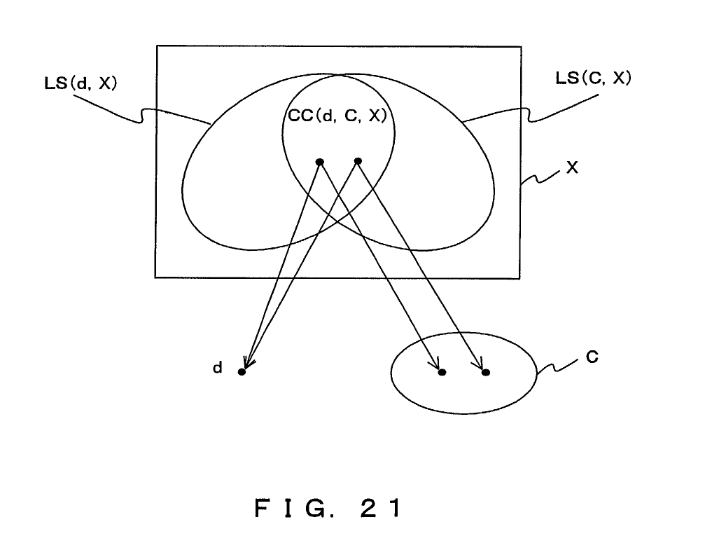

FIG. 20 shows the reference of a document referred to by each set relating to LT(S), LT(p), LS(d, X), and LS(C, X). In FIG. 20, the black dot indicates a document, an arrow indicates a reference, the root of an arrow indicates a reference source, and a point of an arrow indicates a reference target. As shown in FIG. 20, LT(B) and LS(C,X) have arrows directed in the opposite directions. That is, the referred document and the referring document exchange each other. FIG. 21 shows the reference of documents indicated by CC(d, C, X).

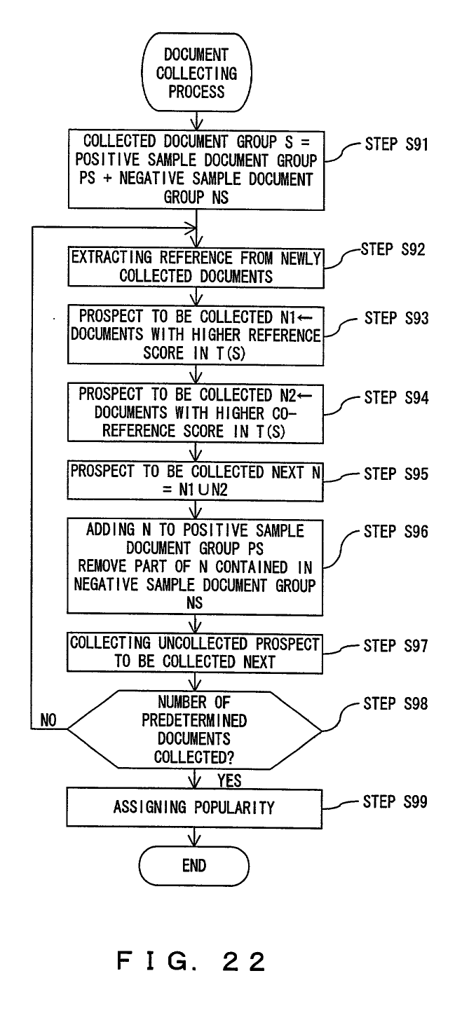

The process of collecting documents relating to a specified field is described below by referring to FIG. 22. For example, the document collection unit 106 collects a predetermined number of documents every week, and assigns an popularity to a collected document. In the process of collecting Web documents according to the present invention, the documents can be collected based on the reference without analyzing the contents of the text of a document when a document similar in field is collected by priority.

First, books or authors to be collected, for example, typical Web documents of an author are collected from among the existing retrieval engine and a link set, and a positive sample document group PS is generated. Similarly, Web documents in a field not overlapping the present field, for example, Web documents of another author are retrieved and collected, and a negative sample document group NS is generated. Hereinafter, it is assumed that the present field is a specified author name, and an example of a field not overlapping the present field is another author name. The positive sample document group PS and the negative sample document group NS are the initial document group. The initial document group refers to a document group at which a document collecting process is started. Then, the URLs and the author IDs of the PS and NS documents are stored in the popular Web document master 13. The sum set PS∪NS of the positive sample document group and the negative sample document group NS is defined as a collected document group S (step S91).

The document collection unit 106 extracts the reference from the initial collected document group S (initial document group) when the collecting process is started, and from a newly collected document thereafter (step S92). The document collection unit 106 computes the reference score the reference score R_{score} (d, PS, S) by the following equation (1) based on the extracted reference relating to the document d∈T (S) contained in the document set T(S)=LT(S)−PS obtained by subtracting the documents contained in the positive sample document group PS from the referred document in the collected document group S. The document collection unit 106 defines the document group having the reference score R_{score} (d, PS, S) contained in the n1 higher order reference scores as N1 (step S93). It is determined whether or not a collected document is contained in the positive sample document group PS by referring to the author ID of the popular Web document master 13.

$${R}_{score} ( d , PS , S ) = log ( \vert LS ( d , PS ) \vert ) \cdot \frac{\vert LS ( d , PS ) \vert}{\vert LS ( d , S ) \vert} \qquad ( 1 )$$

The first term in the equation (1) indicates the logarithm of the number of documents in the positive sample document group referring to the document d. The second term in the equation (1) indicates the ratio of the number of documents in the positive sample document group referring to the document d to the number of collected documents referring to the document d. Therefore, the document d referred to the more frequently by the positive sample document group PS has a larger value of R_{score} (d, PS, S).

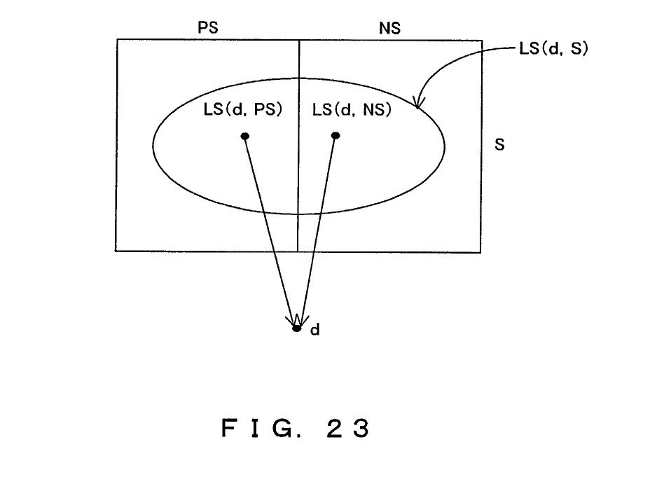

That is, the document collection unit 106 defines the document frequently referred to by the positive sample document group PS relating to a specified field, and less frequently referred to by the negative sample document group NS not relating to the specified field as N1 in the referred documents of newly collected documents based on the reference score R_{score} (d, PS, S). FIG. 23 shows the reference indicated by each set contained in the equation (1) when the reference score is computed for the document d.

Then, the document collection unit 106 computes the co-reference score C_{score} (d, PS, S) by the following equation (2) for the document d∈T(S)−N1. The document collection unit 106 defines the document group having the co-reference score C_{score} (d, PS, S) in the n2 higher order documents in the d∈T(S)−N1 as N2 (step S94).

$${C}_{score} ( d , PS , S ) = log ( {\sum }_{p ∈ CC ( d , PS , S )} \vert LT ( p ) ⋂ PS ) \frac{\vert CC ( d , PS , S ) \vert}{\vert LS ( d , S ) \vert} \qquad ( 2 )$$

The contents of the logarithm of the first term in the equation (2) indicates the sum of products of the number of documents which are referred documents of the document p, and contained in the positive sample document group PS in all collected documents p referring to both document d and documents in the positive sample document group PS. Therefore, a larger value of a co-reference score C_{score} (d, PS, S) is indicated by a document d having a larger number of collected documents p referring to both document d and at least one document in the positive sample document group PS, and by a document d having a larger number of documents which are referred documents referred to by the document p and are contained in the positive sample document group PS. That is, relating to the document d referred to by a collected document referring to a document in the positive sample document group PS, the document d having a larger number of collected documents referring to the document d has a larger value of the co-reference score C_{score} (d, PS, S).

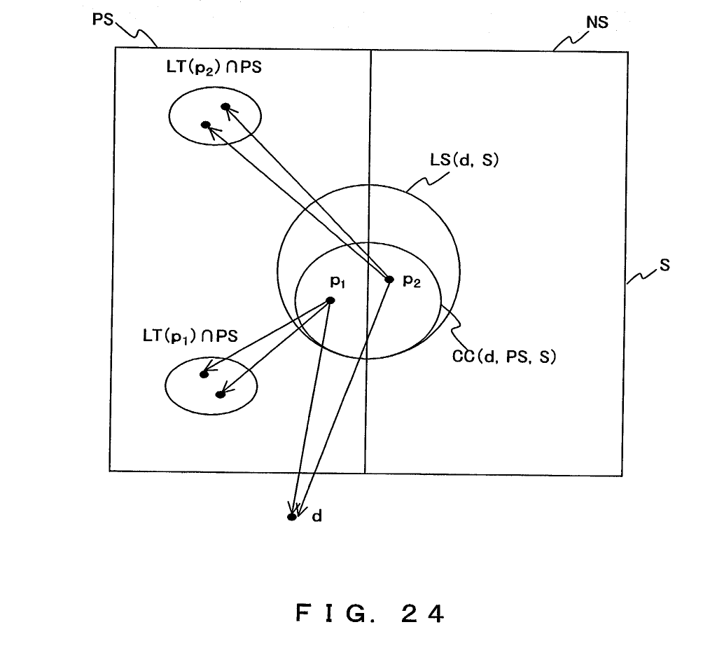

The second term of the equation (2) indicates the ratio of the number of documents p referred to together with the document d to the number of collected documents referring to the document d. The co-reference score C_{score} (d, PS, S) has a larger value when the ratio indicates a larger value. FIG. 24 shows the reference indicated by each set contained in the equation (2) when the co-reference score for the document d is computed.

The document collection unit 106 sets the prospect to be collected next N=N1∪N2 (step S95). The document collection unit 106 searches the popular Web document master 13 using the URL of the prospect to be collected next N as a key, and defines the author ID of the prospect to be collected next N as the author ID of the positive sample document group PS. In this process, the document contained in the negative sample document group NS and determined as the prospect to be collected next is removed from the negative sample document group NS, and added to the positive sample document group PS (step S96).

The document collection unit 106 collects an uncollected document in the prospects to be collected next N from the network based on the URL stored in the popular Web document master 13 (step S97). In this process, a newly collected document is added to the positive sample document group PS. The document collection unit 106 refers to the popular Web document master 13, and determines whether or not the number of documents in the positive sample document group PS is equal to or larger than a predetermined value (step S98). If the number of documents in the positive sample document group is not equal to or larger than a predetermined value (No in step S98), control is returned to step S92 and the processes are repeated.

If the number of documents in the positive sample document group PS is equal to or larger than a predetermined value (Yes in step S98), then the document collection unit 106 ranks the documents in the positive sample document group PS by assigning their popularitys to them (step S99), thereby terminating the process.

Described below is the process of assigning an popularity to a collected document. The document collection unit 106 computes the popularity of each collected document using the reference and URL of the collected document without analyzing the contents of the meaning of the collected document. The popularity assigned to a document based on the reference is referred to as a link popularity. The basic concept of assigning a link popularity is described below.

A document frequently referred to by a document whose URL has low similarity is important.

For example, a plurality of documents provided on the same site are normally referred to by other documents on the site, but their URLs are similar to one another. Therefore, the popularity of the document referred to by the document whose URL is similar is assumed to be low.

A document referred to by a larger number of documents is more important. A document which is referred to by an important document and has low similarity of URL is an important document.

For example, famous directory services, governments and municipal offices, etc. are referred to by a large number of documents. However, a document referred to by an important document is assumed to have a high popularity. In addition, a document, etc. provided on a service (site) containing a large number of documents and mirror site is referred to on the site in most cases. However, since the URLs of the documents on the same site are normally similar, it can be avoided that a number of documents on the same site can be retrieved if the concept that a document having low similarity of URL is important.

The similarity of URL is defined according to the character information of URL such that the lowest similarity can be assigned when all of the server address, path, and file name are different from each other, and the highest similarity can be assigned to the documents on the mirror site or in the same server.

By introducing the above mentioned three concepts, the weight is assigned to the reference depending on the link popularity without equally processing all references. To be more specific, the weight is assigned as a reciprocal of the URL similarity between a referring document (link-source document) and a referred document. Described below in more detail is the computation of a link popularity.

Assuming that a document set for which a link popularity is computed is DOC={p1, p2, . . . , pN}, the link popularity of a document p is Wp, a set of referred documents (reference target documents) of a document p is Ref(p), a set of referring documents (reference source documents) of a document p is Refed(p), the URL similarity between documents p and q is sim(p,q), and a difference level is diff(p,q)=l/sim(p,q), the weight 1w(p,q) of the reference is defined by the following equation (3) if the reference is made from the document p to the document q.

$$Iw ( p , q ) = diff ( p , q ) / {\sum }_{i ∈ Ref ( p )} diff ( p , i ) = \frac{1}{sim ( p , q ) {\sum }_{i ∈ Ref ( p )} \frac{1}{sim ( p , i )}} \qquad ( 3 )$$

As clearly shown by the equation (3) above, 1w(p,q) becomes larger when the similarity sim(p,q) between the URLs of p and q is lower, and when the number of references from p is smaller.

The link popularity of each document can be defined as a solution of the following simultaneous linear equations (4) where Cq is a constant (the lower limit of the popularity, and can be variable depending on the documents) for each p∈DOC.

$$Wq = Cq + {\sum }_{p ∈ Refed ( q )} Wp * Iw ( p , q ) \qquad ( 4 )$$

The document collection unit 106 assigns a link popularity to each document by solving the simultaneous linear equations. The method of solving the simultaneous linear equations can be any of a number of existing algorithms. Therefore, the explanation is omitted here. The equations (3) and (4) show that the above mentioned concept can be realized.

Described next is the URL similarity sim(p,q) between the documents p and q in the equations (3) and (4). The URL similarity is computed by the URL discrimination unit (not shown in the attached drawings) of the document collection unit 106. Normally, the URL of a document comprises three types of information, that is, a server address, a path, and a file name. For example, the URL of a Web document of http://www/flab.fujitsu.co.jp/hypertext/news/1999/product1.htm1 is configured by a server address (www.flab.fujitsu.co.jp), a path (hypertext/news/1999), and a file name (product1.htm1).

According to the present invention, the URL similarity between two given documents p and q is defined by the above mentioned three types of combinations. As the similarity sim(p,q), for example, the domain similarity sim_domain(p,q) and the merger similarity sim_merge(p,q) described below.

The domain similarity sim_domain(p,q) is computed based on the similarity of domains.

A domain refers to a second half of a server address, and indicates a company and an organization. When a server address ends with .com, .edu, .org, etc. indicating the U.S. servers, the description up to the second level from the end corresponds to a domain. When a server address ends with .jp, .fr, etc. indicating the servers in the other countries, the description up to the third level from the end corresponds to a domain.

The domain similarity between the documents p and q is defined by the following equation (5).

sim_domain(p,q)=1/α (when p and q are the same domains) =1 (when p and q are different domains) (5)

where a is α constant, and a real number larger than 0 and smaller than 1.

Furthermore, the similarity sim_merge(p,q) obtained by merging the above mentioned three types of information is defined as follows.

sim_merge(p,q)=(similarity of server address)+(path similarity)+(file name similarity)

Each term on the right side is computed as described below.

The similarity of server addresses is defined by checking the hierarchical levels of the addresses from the lowest level. When the addresses match up to the n-th level, the similarity is 1+n. For example, www.fujitsu.co.jp matches www.flab.fujitsu.co.jp up to the third level. Therefore, the similarity is 4. Since www.fujitsu.co.jp does not match www.fujitru.com at the lowest level (no matching level), the similarity is 1.

The similarity of the paths is defined by comparing each element delimited by ‘/’ from the beginning, and the matching levels are counted for similarity. For example, /doc/patent/index.html matches /doc/patent/1999/2/file.htm1 up to the second level. Therefore, the similarity is 3.

The similarity of file names is 1 when file names match each other.

The sim_merge(p,q) can avoid retrieving a number of documents similar in file name.

Thus, according to the present embodiment, the document collection unit 106 can assign an popularity to a document based on the reference of collected documents in a specified field and the characteristic of the character string of URLs without analyzing the semantic contents of the text of the documents, that is, with high precision at a high processing speed.

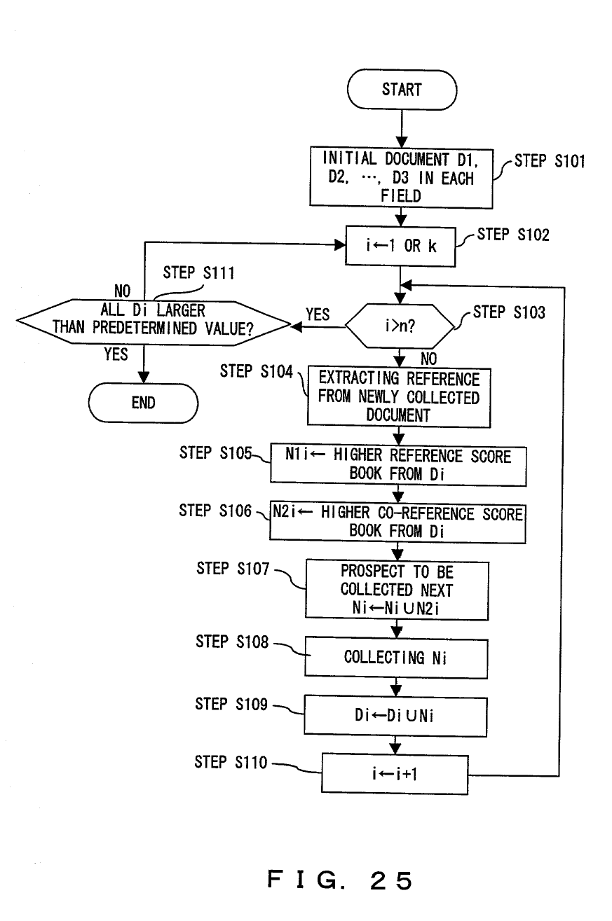

Described below is a variation of the method of collecting documents. Since it is difficult to collect a negative sample document group NS, it is desired to utilize it without discarding it after the collecting process. Therefore, the document collection unit 106 according to the present embodiment, a collected negative sample document group NS is utilized. As a result, documents in a plurality of fields, for example, documents by a plurality of authors can be collected in parallel. Therefore, when a document in a field is collected, a document group in the field is defined as a positive sample document group PS, and a document group in the other fields is defined as a negative sample document group NS. The process performed by the document collection device according to the present embodiment is described below by referring to FIG. 25. In the following explanation, it is assumed that documents by a plurality of authors are simultaneously collected.

First, a document group Di (i=1, 2, . . . , n) in n independent fields are retrieved and collected from a retrieval engine, a link group, etc., and the URLs of the documents of the document group Di, a collection completion flag, field identification information identifying a field (an author ID in this example) are stored in the popular Web document master 13. The document group Di is an initial document group in the field i. The collected document group is described as D=(D1, D2, . . . , Dn) (step S101).

First, the document collection unit 106 assigns i (step S102). When the collecting process starts, the document collection unit 106 sets i to 1. Then, the document collection unit 106 determines whether or not i is larger than n (step S103). If i is larger than n (Yes in step S103), then control is passed to step S71. If not (No in step S103), then the document collection unit 106 extracts the reference from the newly collected document in the document group Di corresponding to the field i (from the initial document group when the collecting process is started), and the URL of the referred document in the popular Web document master 13 (step S104).

The document collection unit 106 defines a document group T(Di)=LT(Di)−D, which are referred documents of the document group Di and not contained in the collected document group D, as a group to be collected next, and computes the reference score R_{score} (d, Di, D) by the equation (1) above for the document d∈T (Di) contained in the group T (Di) to be collected next. The document collection unit 106 defines the document group indicating the reference score R_{score} (d, Di, D) in the n1 highest order as N1i (step S105). The field containing the collected documents can be determined by referring to the author ID of the popular Web document master 13.

The document collection unit 106 computes the co-reference score C_{score} (d, Di, D) by the equation (6) above for the document d∈T (Di)−N1i contained in a group obtained by removing Nli from the group T (Di) to be collected next. The document collection unit 106 defines the document group indicating the co-reference score C_{score} (d, Di, D) in the n2 highest order as N2i (step S106).

The document collection unit 106 defines N1i∪N2i as a prospect to be collected next Ni for the field i (step S107). The document collection unit 106 accesses the popular Web document master 13, and assigns an author ID corresponding to the current value of i to the prospect to be collected next Ni. The document collection unit 106 collects the prospect to be collected next Ni from the network (step S108). Thus, the sales management unit 101 generates a new document group Di by adding a newly collected document group to the document group Di (step S109).

Then, the document collection unit 106 increments i by 1 (step S110), and control is returned to step S103. The document collection unit 106 repeats the above mentioned process until i exceeds n.

If i exceeds n (Yes in step S103), then the document collection unit 106 refers to the popular Web document master 13, counts the number of documents in each document group Di based on the collection completion flag and the author ID, and determines whether or not the number of documents in each document group Di is equal to or larger than a predetermined value (step S111). If there is a document group Dk (k is any number from 1 to n) containing the number of documents smaller than a predetermined value, control is returned to step S102, and the document collection unit 106 repeats the processes in and after step S103 where i=k.

When there are a plurality of document groups Dk containing the number of documents smaller than a predetermined value, for example, Dk1, Dk2 and Dk3, the document collection unit 106 repeats the processes in and after step S103 where i=k1, k2, and k3. When the number of documents in all of the collected document group Di from D1 to Dn is equal to or larger than a predetermined value (Yes in step S71), the process terminates.

Thus, when a document is collected in a field, the document group in the field can be defined as a positive sample document group PS while the sum document group in the other fields can be defined as a negative sample document group NS, thereby not wasting the process on the negative sample document group NS.

Furthermore, when a document group D1 in a field is a positive sample document group PS and documents are to be collected in the field according to the present embodiment, the document group in the other fields as a negative sample document group NS is larger than the positive sample document group PS. Additionally, since the negative sample document group NS itself also relates to other fields, the contents are constant. In a document collecting method according to the conventional method, when the collecting process proceeds to a certain extent, the positive sample document group PS becomes larger while the second term of the R_{score} (d, PS, S) expressed by the equation (5) becomes large by transferring documents from the negative sample document group NS to the positive sample document group PS. As a result, there has been the possibility that the collection precision can be lowered. However, the possibility can be reduced according to the present embodiment.

Described below is the second embodiment. In the first embodiment, the client A enters the information about the owned books in the virtual bookshelf 11. However, books can be read by borrowing them from libraries and friends without purchasing them. It is obvious that books already owned are not to be purchased, and books already read are not to be purchased in most cases. However, books already read can be accidentally purchased. According to the second embodiment, it is possible to store the information about the books read but not purchased in the virtual bookshelf 11.

The system configuration, data structure, and process according to the second embodiment are substantially the same as those according to the first embodiment. Therefore, only the differences from the first embodiment are described below.

According to the second embodiment, the virtual bookshelf by book 111 shown in FIG. 3 stores the information about the status of ‘read but not owned’ in addition to the information about the above mentioned status of ‘purchased at other stores’, ‘purchased at the online bookstore 100’, etc. To be more practical, in addition to the cases where the value of the ownership information in the above mentioned explanation is any of 1 through 4, the case where the value of the ownership information is 5 indicates the status of ‘read but not owned’.

Further, on the list screen shown in FIGS. 7 and 8, the author information display screen shown in FIG. 12, and the book information display screen shown in FIGS. 14 and 15, a ‘read’ button is set in the position on the screen corresponding to the book not owned, that is, the book having the ownership information of 0. For example, in the process of setting the list screen shown in FIG. 6 in step S11, to clearly identify a ‘read’ book, the retrieval unit 105 can replace the display of the information about the ‘read’ books with the display other than the display of owned books and books not owned. Furthermore, the retrieval unit 105 can display a mark in the position on the screen corresponding to a ‘read’ book, and simultaneously set a ‘purchase’ button.

When the client A presses the ‘read’ button on each screen, the virtual bookshelf management unit 102 enters the book corresponding to the pressed button as a ‘read’ book in the virtual bookshelf 11. To be more practical, the virtual bookshelf management unit 102 refers to the virtual bookshelf by book 111 using the book ID of the book corresponding to the pressed button and the client ID of the client A, and updates the ownership information corresponding to the client A and the book into 5. This process is substantially the same as the process of entering an ‘unnecessary’ book in step S16 shown in FIG. 6.

According to the first embodiment, in steps S63 through S65 in the sales agent process shown in FIG. 16, the sales agent unit 103 updates the ownership information stored in the virtual bookshelf by book 111 such that collected books can be designated as books now owned. According to the second embodiment, the sales agent unit 103 updates the ownership information stored in the virtual bookshelf by book 111 such that collected books can be entered as books already read. Therefore, the sales agent unit 103 updates the ownership information about a collected book into 5 instead of performing the processes in steps S63 through S65.

Although the book information display screen about a ‘read’ book is the same as the book information display screen about an owned book shown in FIG. 15, the ‘unnecessary’ button is not displayed. On the owned book list screen shown in FIG. 19, not only ‘owned’ books, but also ‘read’ books can be simultaneously displayed as a simultaneous listing. Additionally, in the relevant book recommending process in step S54 shown in FIG. 13, and the favorite author recommending process in step S84 shown in FIGS. 18, the recommendation unit 104 can remove not only the owned books but also read books from the extracted books.

Thus, the client A can prevent accidentally purchasing an already read book. Additionally, the client A can also manage the information such as opinions, etc. about the books read but not owned.

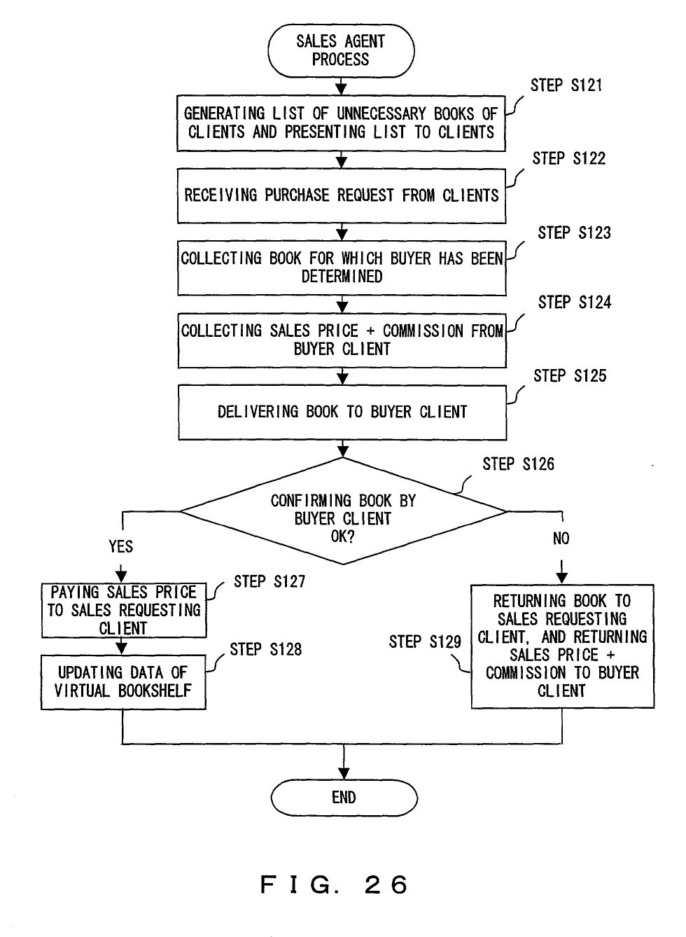

Described below is the online bookstore according to the third embodiment of the present invention. In the first and second embodiments, the online bookstore 100 acts as a sales agent by selling the book unnecessary for the client A to a secondhand bookseller U. According to the third embodiment, the online bookstore acts as a sales agent between clients A. The system configuration, data structure, and process according to the third embodiment are substantially the same as those according to the first embodiment. However, with the system configuration shown in FIG. 2, the sales agent unit 103 acts as a sales agent by selling books to a secondhand bookseller U. According to the third embodiment, the sales agent unit 103 sells books to another client A instead of the secondhand bookseller. Furthermore, the sales agent process according to the third embodiment is performed as shown in FIG. 26. The sales agent process according to the third embodiment is described below by referring to FIG. 26.

First, when the client A presses the ‘unnecessary’ button in step S15 shown in FIG. 6, the client A inputs a requested sales price of the book (not shown in the attached drawings). Then, the sales agent unit 103 generates an unnecessary book list by checking the books defined as unnecessary as in the first embodiment, and makes the list public to the clients A (step S121). The sales agent unit 103 accepts a purchase request for an unnecessary book from any client A (step S122). At a purchase request, a buyer is determined for the corresponding book. The sales agent unit 103 stores the result in the buyer list (not shown in the attached drawings) of the books for which the buyers have been determined. The buyer list contains at least the client ID of the buyer client A, the client ID of the requesting client A, and the book ID of a book to be sold. Then, it is confirmed that a book whose buyer has been determined has been collected (step S123). The collection is confirmed based on the input from the manager of the online bookstore 100.

When it is confirmed that a book has been collected, the sales agent unit 103 instructs the buyer client A to pay the amount computed by adding the commission to the sales price (step S124). If the sales agent unit 103 confirms that the instructed amount has been paid, the sales agent unit 103 delivers the book to the buyer client A (step S125). At this time, when the buyer client A has purchased another book, the books are delivered together.

If the purchase is accepted by the buyer client A as a result of confirming the storage state, etc. of the books (Yes in step S126), the sales agent unit 103 pays the sales price to the requesting client A (step S127). Furthermore, the sales agent unit 103 updates the information about the sold book stored in the virtual bookshelf 11 such that the information can report that the requesting client A does not own the sold book any more. Since this process is the same as the process in steps S63 through S65 in the sales agent process shown in FIG. 16 or the process according to the second embodiment, the explanation is omitted here. Simultaneously, the sales agent unit 103 updates the information stored in the virtual bookshelf 11 such that the information reports that the buyer client A now owns the book. Since this process is the same as the process in steps S27 and S28 in the purchasing process shown in FIG. 9, the explanation is omitted here (step S128).

If the buyer client A rejects purchasing the book as a result of confirming the storage state, etc. of the book (No in step S126), then the sales agent unit 103 returns the book to the requesting client A, and the paid money is returned to the buyer client A (step S129).

Thus, the online bookstore 100 can act as a sales agent between the clients A for the sales of unnecessary books.

Described above is the case in which an online shop sells a book. However, the present invention is not limited to the sales of books. Normally, the present embodiment can be effectively applied to merchandise owned by the client A in various similar types. For example, such merchandise can be magnetic tapes, magneto-optical disks, CDs, DVDs, etc., containing cartoons, music, movies, etc. Considering the sales of unnecessary merchandise, it is desired that the merchandise can be repeatedly used, that is, it is not used up after it is once used.

Furthermore, the present embodiment can be applied to the merchandise to be collected as trading cards such as Magic the Gathering cards (copyrighted article of Wizards of the Coast), baseball cards, basketball cards, pocket monster cards (registered trademark of Nintendo, etc.), Player King (Yugioh) cards (registered trademark of Shueisha), etc. In this case, the name of the merchandise is replaces with a card name. Based on the characteristic of each trading card, the information used as an attribute is appropriately determined. For example, when the merchandise is a Magic the Gathering trading card, color such as black, blue, etc. can be used as an attribute. When the merchandise is a baseball card, a team name can be used as an attribute. When the merchandise is a pocket monster card, ‘fire’, ‘water’, etc. can be used.

In the above mentioned explanation, it is assumed that each merchandise is classified based on one type of attribute, for example, an author name for a book. However, it can also be classified based on a plurality of attributes. For example, in the case of music, a plurality of attributes can be a singer name, a composer name, a song writer, etc.

As described above, according to each embodiment of the present invention, the merits to the clients (consumers) A can be listed below as compared with the conventional technology.

It is not necessary for a client to manage his or her merchandise.

A list of owned merchandise can be checked anywhere.

Merchandise matching the taste of a consumer can be recommended more appropriately than in the conventional technology.

A sales agent sells unnecessary merchandise for a consumer at a higher sales price than in the conventional technology.

Unnecessary merchandise can be collected when ordered merchandise is delivered.

The online bookstore 100 has the following merits.

Clients can be reserved.

Sales promotion activities can be performed depending on each client more appropriately than in the conventional technology according to the information about the merchandise owned by the client.

Requests to sell unnecessary merchandise can be collectively processed to sell the merchandise to a secondhand goods store based on the sales agent function, and a part of the sales price can be obtained as a margin.

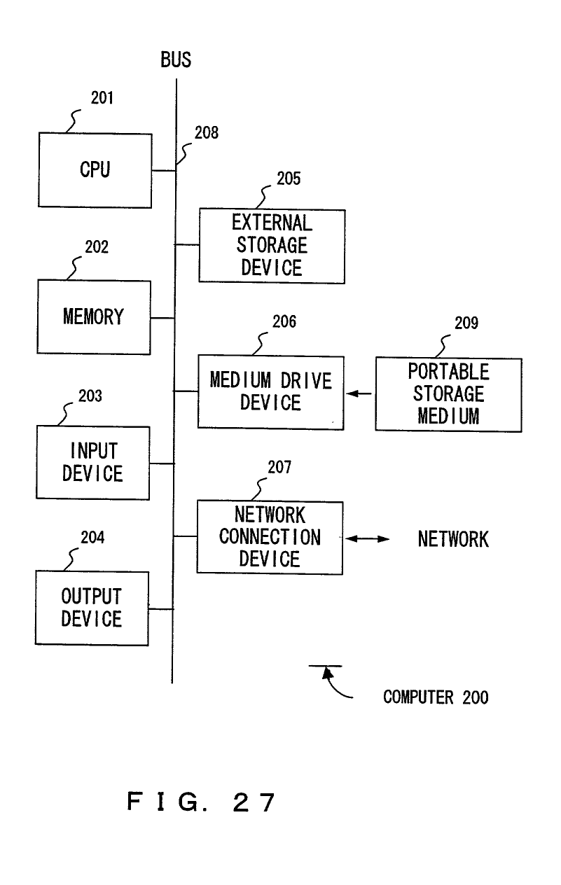

The online shop 100 (server) and each terminal of clients A described above can be configured using a computer (information processing device) as shown in FIG. 27. A computer 200 shown in FIG. 27 comprises a CPU 201, memory 202, an input device 203, an output device 204, an external storage device 205, a medium drive device 206, and a network connection device 207. They are interconnected through a bus 208.

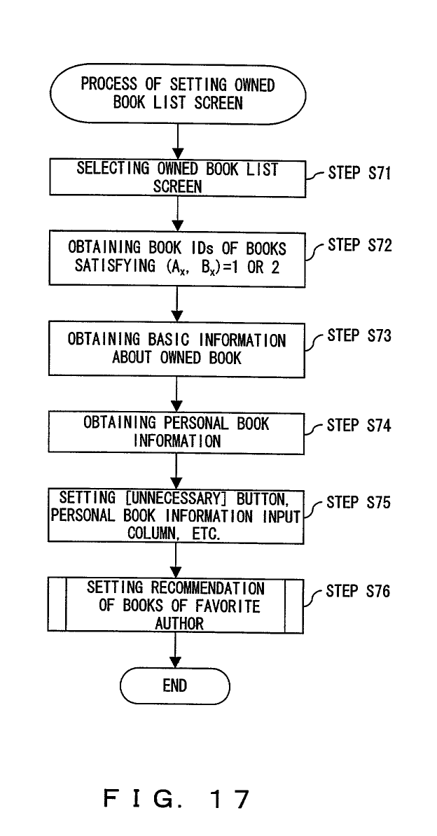

The memory 202 includes, for example, ROM (read only memory), RAM (random access memory), etc., and stores a program and data to direct the computer 200 to perform the process shown in FIGS. 6, 9, 10, 11, 13, 16, 17, 18, 22, 25 and 26. The CPU 201 performs a necessary process by performing a program using the memory 202.

Each unit configuring each of the above mentioned server and terminal is stored in a specific program code segment of the memory 202 as a program. The input device 203 is, for example, a keyboard, a pointing device, a touch panel, etc., and is used in inputting an instruction and information from a user. The output device 204 is, for example, a display, a printer, etc., and is used in issuing an inquiry from the computer 200 to a user, outputting a process result, etc.

The external storage device 205 can be, for example, a magnetic disk device, an optical disk device, a magneto optical disk device, etc. The external storage device 205 stores the above mentioned program and data. The program and data are loaded into the memory 202 and used as necessary.

The medium drive device 206 drives the portable storage medium 209, and accesses the recorded contents. The portable storage medium 209 can be any computer-readable storage medium such as a memory card, a memory stick, a flexible disk, CD-ROM (compact disc read only memory), an optical disk, a magneto-optical disk, a digital versatile disk), etc. The portable storage medium 209 stores the above mentioned program and data, and can be loaded into the memory 202 and used as necessary.

The network connection device 207 communicates with an external device through any network (line) such as a LAN, a WAN, etc., and exchanges data in the communications. In addition, it receives the above mentioned program and data from an external device, loads them into the memory 202, and uses them as necessary.

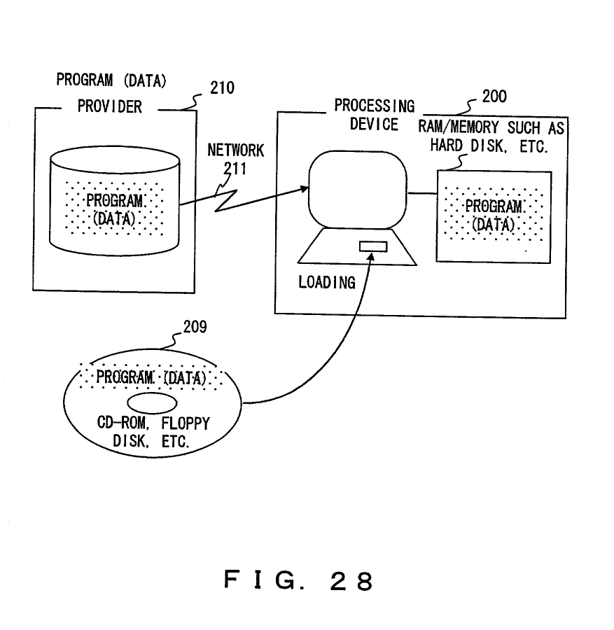

FIG. 28 shows a computer-readable storage medium capable of providing a program and data to the computer 200 shown in FIG. 27, and a transmission signal.

The present invention can also be configured as the computer-readable storage medium 209 used to direct a computer to perform the function realized by each configuration according to the above mentioned embodiments of the present invention.

To attain this, a program for directing a computer to perform the same process as that performed by each device in the above mentioned embodiments is stored in the computer-readable portable storage medium 209 in advance, the program is read by the computer 200 from the portable storage medium 209 as shown in FIG. 28, the read program is temporarily stored in the memory 202 of the computer 200 or the external storage device 205, and then the program is read and executed by the CPU 201 of the computer 200.

Instead of reading the program from the storage medium, the program can be downloaded from a program (data) provider 210 to the computer 200. When the program is downloaded into the computer 200, a transmission signal transmitted through a line 211 (transmission medium) can be used to direct a general-purpose computer to perform the function corresponding to each device described above in the embodiments of the present invention.

The embodiments of the present invention are described above, but the present invention is not limited to the above mentioned embodiments, but a number of other variations can be realized.

For example, by appropriately combining the units forming the online bookstore (online shop) 100 shown in FIG. 2, any device can be configured depending on each purpose.

For example, each unit and DB configuring an online shop operates in cooperation with each other to realize a series of business process. These unit and DB can be provided in the same server, or can operate in cooperation with each other in a different server through a network N.

As described above, according to the present invention, by attaching a function to manage information about merchandise owned by a consumer to a device communicating via a network, it makes it possible for the customer to be free from the bothersome job of managing the owned merchandise by himself or by herself. Furthermore, because the consumer may browse the information about merchandise owned by himself or herself via the network at any time, it makes it possible for the customer to prevent accidentally purchasing the merchandise owned by himself or herself.

Furthermore, by attaching the function described above to an online shop, it makes it possible for the online shop to provide better service to its customers.

While the invention has been described with reference to the preferred embodiments thereof, various modifications and changes may be made to those skilled in the art without departing from the true spirit and scope of the invention as defined by the claims thereof.

What is claimed is:

1. A method for managing merchandise owned by a consumer, comprising:
receiving designation of merchandise owned by the consumer through a network; and
managing information relating to the merchandise owned by the consumer based on the designation.

2. The method according to claim 1, further comprising
automatically designating purchased merchandise as the merchandise owned by the consumer, and managing information about the purchased merchandise when the consumer purchases the merchandise through the network.

3. The method according to claim 1, further comprising:
receiving designation of unnecessary merchandise through the network; and
releasing designation of merchandise as owned by the consumer for the unnecessary merchandise.

4. The method according to claim 1, further comprising:
determining whether or not the consumer has already owned ordered merchandise according to information about the merchandise owned by the consumer when an order for merchandise is received from the consumer through the network; and
transmitting a determination result to the consumer through the network when it is determined that the consumer has already owned the ordered merchandise.

5. The method according to claim 1, further comprising:
receiving designation of merchandise not owned but ever used by the consumer through the network; and
managing information about merchandise ever used by the consumer.

6. A method for outputting a retrieval result after retrieving merchandise to a terminal of a consumer, comprising:
managing information about merchandise owned by the consumer; and
outputting the retrieval result to a terminal of the consumer according to information about merchandise owned by the consumer.

7. The method according to claim 1, further comprising:
determining merchandise to be recommended according to information about merchandise owned by the consumer; and
transmitting information about merchandise to be recommended to the consumer through the network.

8. The method according to claim 7, further comprising
transmitting information about the merchandise to be recommended and also input by another consumer when the recommendation is performed.

9. The method according to claim 7, further comprising when the merchandise is recommended:
classifying each piece of merchandise based on an attribute which is information indicating a tendency of taste; and
determining an attribute matching the taste of the consumer according to information about merchandise owned by the consumer, and transmitting information about merchandise classified into the determined attribute to the consumer.

10. The method according to claim 7, further comprising:
removing merchandise owned by the consumer from merchandise to be recommended according to information about merchandise owned by the consumer when the recommendation is performed.

11. The method according to claim 7, further comprising:
when the recommendation is performed,
extracting a second piece of merchandise likely to be owned together with a first piece of merchandise by the consumer who owns the first piece of merchandise according to information about merchandise owned by the consumer and another consumer; and
transmitting information about the extracted second piece of merchandise to the consumer.

12. The method according to claim 7, further comprising:
when the recommendation is performed,
classifying each piece of merchandise based on an attribute which is information indicating a tendency of taste;
determining an attribute matching a taste of the consumer according to information about merchandise owned by the consumer;
extracting merchandise which is likely to be owned together with merchandise classified into the determined attribute, and is classified into an attribute other than the determined attribute according to information about merchandise owned by the consumer and another consumer; and
transmitting information about an attribute to which the extracted merchandise is classified to the consumer.

13. The method according to claim 7, wherein:
said merchandise is a copyrighted article; and
said attribute is an author name.

14. The method according to claim 1, further comprising:
receiving information designating unnecessary merchandise from a plurality of consumers;
collecting the received information about unnecessary merchandise; and
presenting a collection result to a buyer.

15. A method for distributing merchandise by collecting unnecessary merchandise while selling merchandise to a consumer through a network, comprising:
receiving information designating the unnecessary merchandise from the consumer through the network; and
determining to collect the designated unnecessary merchandise when the consumer has ordered another piece of merchandise and the other piece of merchandise is delivered to the consumer.

16. A method for providing information about merchandise to a consumer through a network, comprising:
collecting a document relating to each piece of merchandise based on a reference between documents in the network; and
transmitting information indicating a location of the collected document in the network to the consumer together with the information about the merchandise.

17. The method according to claim 16, further comprising in collecting the document:
setting a positive sample document group about given merchandise, and a negative sample document group about merchandise not much related to the given merchandise;
determining a document to be collected based on a reference of the positive sample document group and the negative sample document group; and
collecting a document to be collected from the network.

18. A method for managing owned merchandise, comprising:
transmitting information designating the owned merchandise to a server connected through a network; and
receiving the information about the owned merchandise based on the transmitted information from the server.

19. A storage medium storing a program used to direct a computer to control management of merchandise owned by a consumer and perform a process comprising:
receiving designation of merchandise owned by the consumer through a network;
managing information relating to the merchandise owned by the consumer based on the designation; and
transmitting the information about the owned merchandise to the consumer through the network.

20. A storage medium storing a program used to direct a computer to collect unnecessary merchandise while delivering merchandise to a consumer through a network and perform a process comprising:
receiving information designating the unnecessary merchandise from the consumer through the network; and
determining to collect the designated unnecessary merchandise when the consumer has ordered another piece of merchandise and the other piece of merchandise is delivered to the consumer.

21. A merchandise management apparatus which manages merchandise owned by a consumer, comprising:
a network connection unit connected to a network;
an owned merchandise management unit managing information about merchandise owned by the consumer at an instruction received from the consumer through the network.

22. A computer data signal embodied in a carrier wave storing a computer program used to direct a computer to control management of merchandise owned by a consumer through a network, and perform the process comprising:
receiving designation of merchandise owned by the consumer through a network; and
managing information relating to the merchandise owned by the consumer based on the designation.

23. A computer data signal embodied in a carrier wave storing a computer program used to direct a computer to collect unnecessary merchandise while delivering merchandise to a consumer through a network, and perform the process comprising:
receiving information designating the unnecessary merchandise from the consumer through the network; and
determining to collect the designated unnecessary merchandise when the consumer has ordered another piece of merchandise and the other piece of merchandise is delivered to the consumer.
